(19) United States
(12) Patent Application Publication
(10) Pub. No.: US 2025/0386349 A1
(43) Pub. Date: Dec. 18, 2025

(54) RACH PUSCH TRANSMISSION CONFIGURATION IN MULTIPLE TRP TRANSMISSION

(71) Applicant: QUALCOMM Incorporated, San Diego, CA (US)

(72) Inventors: Mostafa KHOSHNEVISAN, San Diego, CA (US); Shaozhen GUO, Beijing (CN); Xiaoxia ZHANG, San Diego, CA (US); Tao LUO, San Diego, CA (US)

(21) Appl. No.: 18/879,678

(22) PCT Filed: Aug. 12, 2022
(86) PCT No.: PCT/CN2022/111988

§ 371 Date: Dec. 27, 2024

(51) Int. Cl. H04W 72/21; H04B 7/06; H04W 74/0833

(52) U.S. Cl. CPC H04W 72/21; H04B 7/0626; H04W 74/0833

(57) ABSTRACT

The UE configured with a multi-DCI based mTRP transmission may be configured to obtain a first SRS resource set associated with a first PUSCH carrying a random access message to be transmitted to a network node, the first PUSCH being scheduled to overlap at least in part with a second PUSCH in a time domain, and transmit or refrain from transmitting, to a network node, the first PUSCH based on the first SRS resource set and a second SRS resource set associated with the second PUSCH. The UE may also obtain a closed loop index associated with a first PUSCH carrying a random access message to be transmitted to a network node, and transmit, to the network node, the first PUSCH carrying the random access message based on the closed loop index.

### TECHNICAL FIELD

The present disclosure relates generally to communication systems, and more particularly, to a wireless communication including physical uplink shared channel (PUSCH) transmission configuration for random access message in a multiple transmit/receive point (mTRP) transmission.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment (UE) configured to obtain a first SRS resource set associated with a first PUSCH carrying a random access message to be transmitted to a network node, the first PUSCH being scheduled to overlap at least in part with a second PUSCH in a time domain, and transmit or refrain from transmitting, to the network node, the first PUSCH based on the first SRS resource set and a second SRS resource set associated with the second PUSCH.

In an aspect of the disclosure, a method, a computer-readable medium, and an apparatus are provided. The apparatus may be a UE configured to obtain a closed loop index associated with a first PUSCH carrying a random access message to be transmitted to a network node, the closed loop index indicating that a first closed loop adjustment state from the first closed loop adjustment state and a second closed loop adjustment state is to be reset, and transmit, to the network node, the first PUSCH carrying the random access message based on the closed loop index.

In an aspect of the disclosure, a method, a computer-readable medium, and an apparatus are provided. The apparatus may be a network node configured to transmit, for a UE an indication of at least one of a first SRS resource set or a closed loop index associated with a first PUSCH carrying a random access message to be transmitted to a network node, the first PUSCH being scheduled to overlap at least in part with a second PUSCH in a time domain, and receive at least one of the first PUSCH or the second PUSCH based on the first SRS resource set and a second SRS resource set associated with the second PUSCH.

In an aspect of the disclosure, a method, a computer-readable medium, and an apparatus are provided. The apparatus may be a network node configured to transmit, for a UE an indication of a closed loop index associated with a first PUSCH carrying a random access message to be transmitted by the UE, and receive the first PUSCH carrying the random access message based on the closed loop index.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A is a diagram illustrating an example of multiple TRP (mTRP) transmission.

FIG. 4B illustrates an example showing multiple CORESET pools.

FIGS. 5A and 5B illustrates random access procedures.

FIGS. 6A, 6B, 6C, and 6D illustrate resource allocations of a first PUSCH and a second PUSCH.

FIG. 7 is a call-flow diagram of a method of wireless communication.

FIG. 8 is a flowchart of a method of wireless communication.

FIG. 9 is a flowchart of a method of wireless communication.

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a diagram illustrating an example of a hardware implementation for an example apparatus and/or network entity.

FIG. 15 is a diagram illustrating an example of a hardware implementation for an example network entity.

FIG. 16 is a diagram illustrating an example of a hardware implementation for an example network entity.

### DETAILED DESCRIPTION

In a multiple DCI based multiple transmit/receive point (TRP) transmission, a user equipment (UE) may differentiate different TRPs based on a parameter associated with the corresponding control resource set (CORESET) (e.g., coresetPoollndex). When two physical uplink shared channels are scheduled to overlap at least in part with each other, the UE may determine to transmit the two overlapping PUSCHs based on the parameter associated with the corresponding CORESET indicating that the two overlapping PUSCHs are scheduled for two different TRPs. Current disclosure may provide examples of obtaining the parameter associated with the CORESET and/or associated power control parameter when at least one PUSCH of the two overlapping PUSCHs are carrying random access message (e.g., Msg3 or MsgA).

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

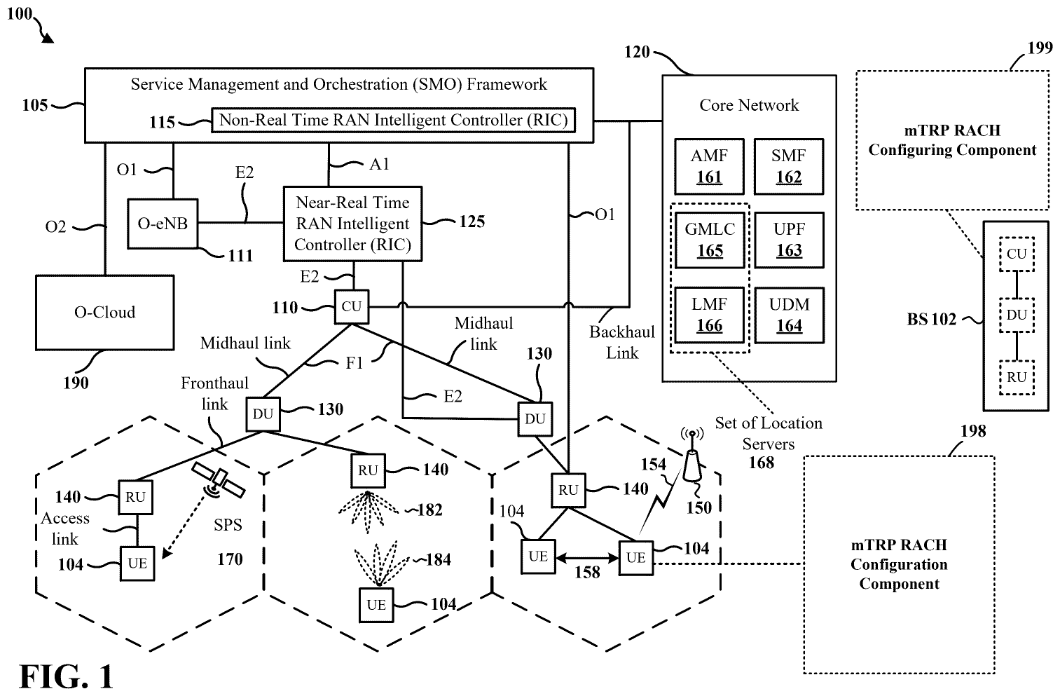

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include an mTRP RACH configuration component 198 configured to obtain a first SRS resource set associated with a first PUSCH carrying a random access message to be transmitted to a network node, the first PUSCH being scheduled to overlap at least in part with a second PUSCH in a time domain, and transmit or refrain from transmitting, to the network node, the first PUSCH based on the first SRS resource set and a second SRS resource set associated with the second PUSCH. In certain aspects, the UE 104 may include an mTRP RACH configuration component 198 configured to obtain a closed loop index associated with a first PUSCH carrying a random access message to be transmitted to a network node, the closed loop index indicating that a first closed loop adjustment state from the first closed loop adjustment state and a second closed loop adjustment state is to be reset, and transmit, to the network node, the first PUSCH carrying the random access message based on the closed loop index. In certain aspects, the base station 102 may include an mTRP RACH configuring component 199 configured to transmit, for a UE an indication of at least one of a first SRS resource set or a closed loop index associated with a first PUSCH carrying a random access message to be transmitted to a network node, the first PUSCH being scheduled to overlap at least in part with a second PUSCH in a time domain, and receive at least one of the first PUSCH or the second PUSCH based on the first SRS resource set and a second SRS resource set associated with the second PUSCH. In certain aspects, the base station 102 may include an mTRP RACH configuring component 199 configured to transmit, for a UE an indication of a closed loop index associated with a first PUSCH carrying a random access message to be transmitted by the UE, and receive the first PUSCH carrying the random access message based on the closed loop index. Although the following description may be focused on 5G NR, the concepts described herein may be applicable to other similar areas, such as LTE, LTE-A, CDMA, GSM, and other wireless technologies.

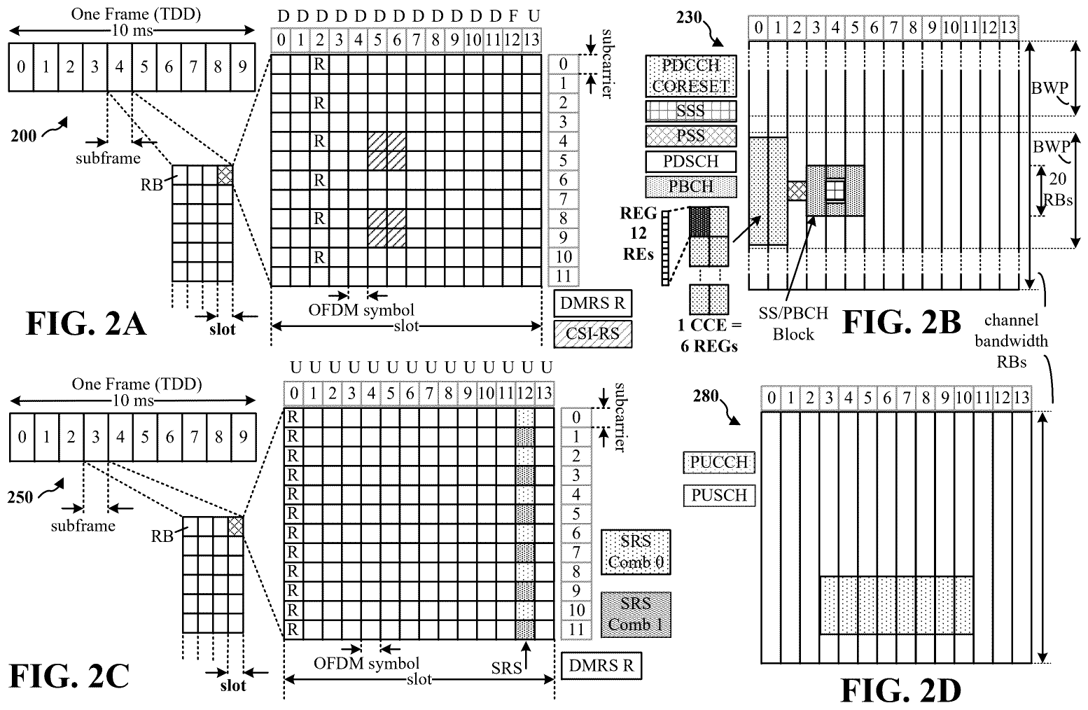

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through download control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology p, there are 14 symbols/slot and 2^{μ}slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

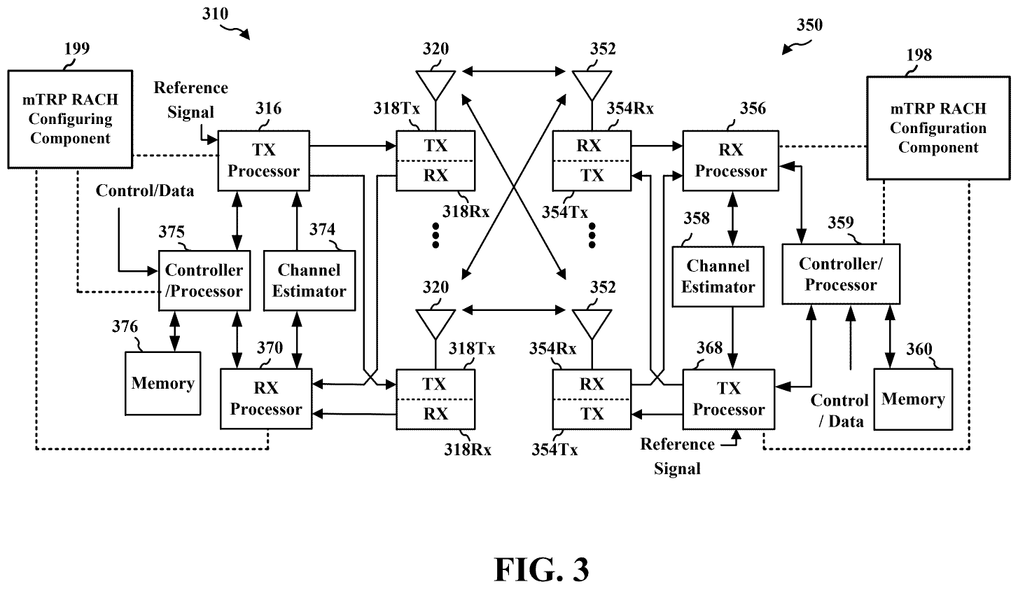

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the mTRP RACH configuration component 198 of FIG. 1. At least one of the TX processor 316, the RX processor 370, and the controller/processor 375 may be configured to perform aspects in connection with the mTRP RACH configuring component 199 of FIG. 1.

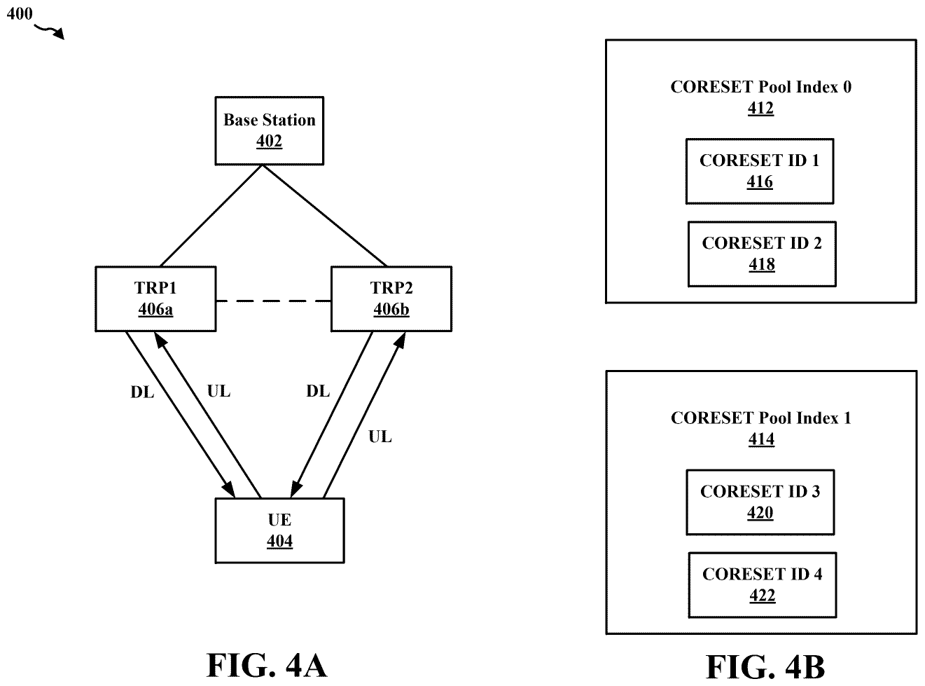

FIG. 4A is a diagram 400 illustrating an example of multiple TRP (mTRP) transmission. The diagram 400 may include a base station 402, a UE 404, a first TRP 406a (“TRP1”), and a second TRP 406b (“TRP2”). In the illustrated example, the base station 402 and the UE 404 are operating in a mTRP communication mode in which the base station 402 is connected to the first TRP 406a and the second TRP 406b, which are connected to the UE 404. Accordingly, a message transmitted by the base station 402 and received by the UE 404 (or transmitted by the UE 404 and received by the base station 402) may be communicated via one or both of the first TRP 406a and the second TRP 406b. For example, with respect to a downlink message transmitted by the base station 402 to the UE 404, the downlink message may be transmitted by the base station 402 to one or both of the first TRP 406a and the second TRP 406b, and then by the one or both of the first TRP 406a and the second TRP 406b to the UE 404.

In some aspects, a first PDCCH transmission may be transmitted to the UE via the TRP 406a and a second PDCCH transmission may be transmitted to the UE via the TRP 406b. In some aspects, the UE 404 may transmit a first PUSCH to the first TRP 406a and a second PUSCH to the second TRP 406b. FIG. 4B illustrates an example showing multiple CORESET pools, e.g., CORESET pool index 0 (412) and CORESET pool index 1 (414). CORESET pool index 0 includes a first CORESET (e.g., CORESET ID 1 416) and a second CORESET (e.g., CORESET ID 2 418). CORESET pool index 1 includes a first CORESET (e.g., CORESET ID 3 420) and a second CORESET (e.g., CORESET ID 4 422).

For example, the downlink message may be transmitted by the base station 402 and received by the first TRP 406a, and then the downlink message may be transmitted by the first TRP 406a and received by the UE 404. In some examples, the downlink message may be transmitted by the base station 402 and received by the second TRP 406b, and then the downlink message may be transmitted by the second TRP 406b and received by the UE 404. In some examples, the downlink message may be transmitted by the base station 402 and received by the first TRP 406a and the second TRP 406b, and then the downlink message may be transmitted by the first TRP 406a and the second TRP 406b and received by the UE 404.

In some aspects, the diagram 400 may be a multi-DCI based mTRP transmission. The first TRP 406a may transmit a first DCI to the UE 404 to schedule a first PUSCH to be transmitted to the first TRP 406a, and the second TRP 406b may transmit a second DCI to the UE 404 to schedule a second PUSCH to be transmitted to the second TRP 406b.

In case the UE 404 is configured with the multi-DCI based mTRP transmission, the UE 404 may be configured with a higher layer parameter (e.g., PDCCH-Config) that contains two different values of CORESET pool parameter (e.g., which may be referred to as a “coresetPoolIndex”) in CORESETs for the active BWP of a serving cell. The CORESET pool parameter (e.g., coresetPoollndex) may indicate that the CORESETs associated with each PDCCH and PDSCH are grouped into different pools. For example, the value of CORESET pool parameter may have a value of 0 or 1, and at least one CORESET (e.g., a maximum number of 5 CORESETs) may be configured with a value of CORESET pool parameter. From the perspective of the UE 404 communicating with the base station 402 through the first TRP 406a and the second TRP 406b, the distinction, e.g., differentiation, between the first TRP 406a and the second TRP 406b may be made based on the CORESET pool parameter.

In some aspects, the UE 404 may be configured with multiple PUSCHs that overlap each other at least in part in a time domain. That is, two different PUSCHs in the same serving cell and/or CC may partially or fully overlap each other in the time domain, but the two PUSCHs may or may not overlap in a frequency domain. The base station 402 and the UE 404 may support the transmission of the time overlapping multiple PUSCHs may be supported based on multi-DCI based mTRP transmission with multiple PUSCHs associated with different CORESET pool parameter (e.g., coresetPoollndex) values. Unlike a spatial division multiplexing (SDM) or frequency division multiplexing (FDM) PUSCH with a single-DCI based framework where simultaneous transmission may be transmitted within a single PUSCH, the base station 402 and the UE 404 configured with multi-DCI based mTRP transmission may support transmitting the two time overlapping PUSCHs based on the two PUSCHs being associated with different TRPs. That is, if the first PUSCH associated with the first TRP 406a and the second PUSCH associated with the second TRP 406b are scheduled to overlap at least in part with each other in the time domain, the UE 404 may have an option to transmit the first PUSCH and the second PUSCH overlapping in time to the respective TRPs together. Particularly, the first PUSCH, associated with coresetPoollndex value of 0, may be associated with the first SRS resource set, and may be transmitted using a first beam (e.g., associated with a first SSB/CSI-RS), a first TCI state, a first set of power control parameters, or a first precoder and the second PUSCH, associated with coresetPoollndex value of 1, may be associated with the second SRS resource set and may be transmitted using a second beam (e.g., associated with a second SSB/CSI-RS), a second TCI state, a second set of power control parameters, or a second precoder.

A UE may use a random access procedure in order to communicate with a base station. For example, the UE may use the random access procedure to request an RRC connection, to re-establish an RRC connection, resume an RRC connection, etc. A UE may use a random access procedure in order to communicate with a base station. For example, the UE may use the random access procedure to request an RRC connection, to re-establish an RRC connection, resume an RRC connection, etc. Random Access Procedures may include two different random access procedures, e.g., The UE may use Contention Based Random Access (CBRA) may be performed when a UE is not synchronized with a base station, and contention free random access (CFRA) may be applied, e.g., when the UE was previously synchronized to a base station. Both the procedures include transmission of a random access preamble from the UE to the base station. In CBRA, a UE may randomly select a random access preamble sequence, e.g., from a set of preamble sequences. As the UE randomly selects the preamble sequence, the base station may receive another preamble from a different UE at the same time. Thus, CBRA provides for the base station to resolve such contention among multiple UEs. In CFRA, the network may allocate a preamble sequence to the UE rather than the UE randomly selecting a preamble sequence. This may help to avoid potential collisions with a preamble from another UE using the same sequence. Thus, CFRA is referred to as “contention free” random access.

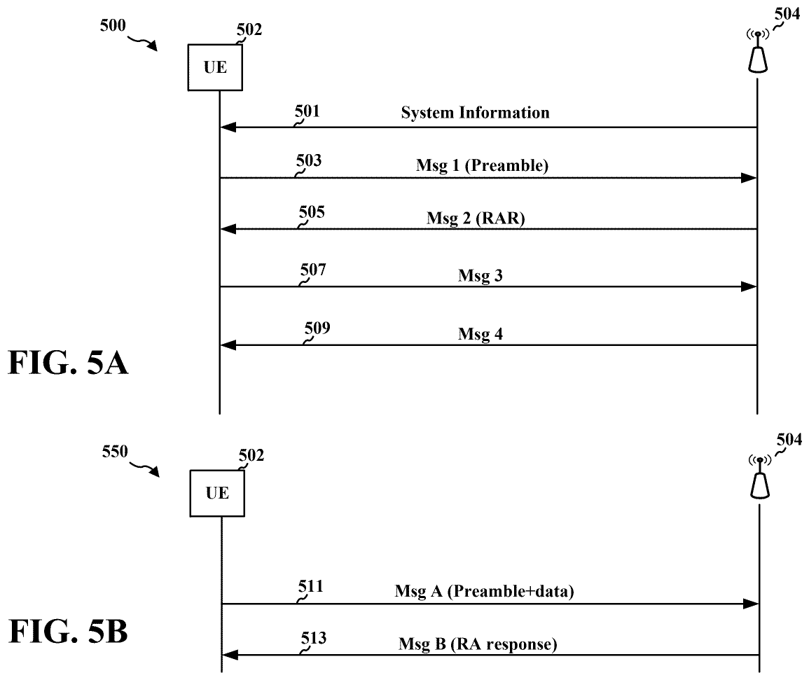

FIGS. 5A and 5B illustrates random access procedures. FIG. 5A illustrates a 4-step random access procedure 500 between a UE 502 and a base station 504. The UE 502 may initiate the random access message exchange by sending, to the base station 504, a first random access message 503 (e.g., Msg1) including a preamble. Prior to sending the first random access message 503, the UE may obtain random access parameters, e.g., including preamble format parameters, time and frequency resources, parameters for determining root sequences and/or cyclic shifts for a random access preamble, etc., e.g., in system information 501 from the base station 504. The preamble may be transmitted with an identifier, such as a Random Access RNTI (RA-RNTI). The UE 502 may randomly select a random access preamble sequence, e.g., from a set of preamble sequences. If the UE 502 randomly selects the preamble sequence, the base station 504 may receive another preamble from a different UE at the same time. In some examples, a preamble sequence may be assigned to the UE 502. The power control of the MSG1 may be associated with the PRACH. For example, the UE 502 may configure a path-loss reference signal (PL-RS) may be based on the SSB or CSI-RS associated with the PRACH. The UE 502 may be configured with beam reciprocity, and the UL beam for the PRACH may be based on the DL beam of the SSB or CSI-RS associated with the PRACH.

The base station may respond to the first random access message 503 by sending a second random access message 505 (e.g. Msg2) using PDSCH and including a random access response (RAR). The RAR may include, e.g., an identifier of the random access preamble sent by the UE, a time advance (TA), an uplink grant for the UE to transmit data (e.g., Msg3) including frequency domain resource allocation (FDRA), time domain resource allocation (TDRA), modulation and coding scheme (MCS), transmit power control (TPC), etc., temporary cell radio network temporary identifier (TC-RNTI) or other identifier, and/or a back-off indicator. The Msg2 may include a PDCCH and corresponding PDSCH. In one example, the PDCCH of the Msg2 may include a DCI format 1_1 with CRC scrambled with RA-RNTI obtained based on Msg1 transmission, and the PDCCH may be received by the UE within a RAR window after the UE 502 transmits the Msg1 (e.g., a type-1 PDCCH CSS set).

Upon receiving the second random access message 505 including the RAR, the UE 502 may transmit a third random access message 507 (e.g., Msg3) to the base station 504, e.g., using PUSCH, that may include a RRC connection request, an RRC connection re-establishment request, or an RRC connection resume request, depending on the trigger for the initiating the random access procedure. The base station 504 may then complete the random access procedure by sending a fourth random access message 509 (e.g., Msg4) to the UE 502, e.g., using PDCCH for scheduling and PDSCH for the message. The UE 502 may use the same transmit beam as the Msg1, using the same power control (e.g., PL-RS) as the Msg1.

The fourth random access message 509 may include a random access response message that may include contention resolution information, and/or RRC connection setup information. The UE 502 may monitor for PDCCH, e.g., with the C-RNTI or the TC-RNTI. If the PDCCH is successfully decoded, the UE 502 may also decode PDSCH. The UE 502 may send HARQ feedback for any data carried in the fourth random access message. If two UEs sent a same preamble at 703, both UEs may receive the RAR leading both UEs to send a third random access message 507. The base station 504 may resolve such a collision by being able to decode the third random access message from only one of the UEs and responding with a fourth random access message to that UE. The other UE, which did not receive the fourth random access message 509, may determine that random access did not succeed and may re-attempt random access. Thus, the fourth message may be referred to as a contention resolution message. The fourth random access message 509 may complete the random access procedure. Thus, the UE 502 may then transmit uplink communication and/or receive downlink communication with the base station 504 based on the fourth random access message 509 including the RAR.

FIG. 5B illustrates a 2-step random access procedure 550 between the UE 502 and the base station 504. In order to reduce latency or control signaling overhead, a single round trip cycle between the UE and the base station may be achieved in a 2-step RACH process 550, such as shown in FIG. 5B. Aspects of Msg1 and Msg3 may be combined in a single message, e.g., which may be referred to as Msg A. The Msg A may include a random access preamble, and may also include a PUSCH transmission, e.g., such as data. The MsgA preambles may be separate from the four step preambles, yet may be transmitted in the same random access occasions (ROs) as the preambles of the four step RACH procedure or may be transmitted in separate ROs. The PUSCH transmissions may be transmitted in PUSCH occasions (POs) that may span multiple symbols and PRBs. In one example, the MsgA PUSCH may be referred to as the MsgA payload. The parameters and resource allocation for the MsgA may be given in the SIB or a dedicated RRC configuration (e.g., MsgA-PUSCH-Config-r16)

After the UE 502 transmits the Msg A 511, the UE 502 may wait for a response from the base station 504. Additionally, aspects of the Msg2 and Msg4 may be combined into a single message, which may be referred to as Msg B. Two step RACH may be triggered for reasons similar to a four-step RACH procedure. If the UE does not receive a response, the UE may retransmit the MsgA or may fall back to a four-step RACH procedure starting with a Msg1. If the base station detects the Msg A, but fails to successfully decode the Msg A PUSCH, the base station may respond with an allocation of resources for an uplink retransmission of the PUSCH. The UE may fallback to the four step RACH with a transmission of Msg3 based on the response from the base station and may retransmit the PUSCH from Msg A. If the base station successfully decodes the Msg A and corresponding PUSCH, the base station may reply with an indication of the successful receipt, e.g., as a random access response 513 that completes the two-step RACH procedure. The Msg B may include the random access response and a contention-resolution message. The contention resolution message may be sent after the base station successfully decodes the PUSCH transmission.

In some aspects, a UE may transmit a PUSCH on active UL BWP b of carrier f of serving cell c using parameter set configuration with index j and PUSCH power control adjustment state with index 1, and the UE may determine the PUSCH transmission power P_{PUsCH,b,f,c}(i, j, q_{d}, l) in PUSCH transmission occasion i as a UL transmission power of the Msg3 or and MsgA PUSCH as represented as follows:

$${P}_{PUSCH , b , f , c} ( i , j , {q}_{d} , l ) = min \{ \begin{matrix}{P}_{CMAX , f , c} ( i ) , \\ {P}_{O \_ PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l )\end{matrix} \}$$

Here, j=0 corresponds to Msg3 PUSCH (e.g., PUSCH transmission or retransmission corresponding to a RAR UL grant), or a MsgA payload (PUSCH transmission for the 2-step RACH), or if the UE establishes dedicated RRC connection using a random access procedure (e.g., the 4-step RACH or the 2-step RACH) but before RRC configuration of power control parameters for PUSCH. Also, P₀ may be represented as preambleReceivedTargetPower+msg3−DeltaPreamble, or preambleReceivedTargetPower+msgA−DeltaPreamble. Here, preambleReceivedTargetPower may be configured for the PRACH. msg3-DeltaPreamble and msgA-DeltaPreamble may be the power offset between the RACH preamble transmission and one of the Msg3-payload or the MsgA-payload. Here, msg3-DeltaPreamble may be associated with the 4-step RACH, and msgA-DeltaPreamble may be associated with the 2-step RACH. Alpha (α) may be configured by Msg3-Alpha or MsgA-Alpha, or as 1 if not configured. The PL may be based on the RS index (e.g., the SSB/CSI-RS) associated with the PRACH transmission.

Based on receiving a RAR message in response to a PRACH transmission or receiving a MsgA transmission, the UE may reset the closed loop power control adjustment f(i, l) for l=0 (e.g., the first closed loop index) to the following: In one aspect, in response to receiving the RAR message which includes UL grant for Msg3 payload (e.g., Msg3 PUSCH), the closed loop power control adjustment may be reset to f_{b,f,c}(0, l)=ΔP_{rampup,b,f,c}+δ_{msg2,b,f,c}, where l=0. Here, ΔP_{rampup,b,f,c} may represent the total power ramp-up from the first to the last RACH attempts, and δ_{msg2,b,f,c} may refer to the TPC command value indicated in the RAR message. In another aspect, in response to transmitting the MsgA-payload (e.g., MsgA PUSCH), the closed loop power control adjustment may be reset to f_{b,f,c}(0, l)=ΔP_{rampup,b,f,c}. TPC command is not available in case of the 2-step random access procedure.

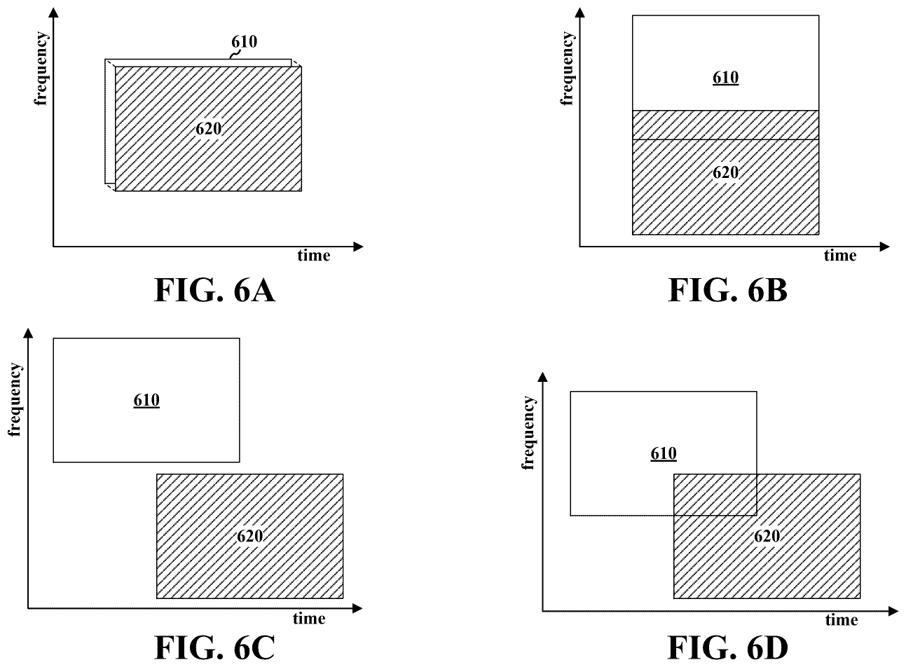

FIGS. 6A, 6B, 6C, and 6D illustrate resource allocations of a first PUSCH 610 and a second PUSCH 620 that may overlap each other in at least one of a time domain or a frequency domain. FIG. 6A shows that the first PUSCH 610 and the second PUSCH 620 may fully overlap with each other in the time domain and the frequency domain. FIG. 6B shows that the first PUSCH 610 and the second PUSCH 620 may fully overlap with each other in the time domain, and partially overlap with each other in the frequency domain. FIG. 6C shows that the first PUSCH 610 and the second PUSCH 620 may partially overlap with each other in the time domain and do not overlap with each other in the frequency domain. FIG. 6D shows that the first PUSCH 610 and the second PUSCH 620 may partially overlap with each other in the time domain and the frequency domain.

In some aspects, a UE configured with multi-DCI based mTRP transmission may obtain or determine the CORESET pool parameter (e.g., coresetPoollndex) associated with the Msg3 PUSCH or the MsgA PUSCH. That is, one of the conditions to determining whether two PUSCHs may be transmitted simultaneously (e.g. or overlapping at least in part in the time domain) may be that the two overlapping PUSCHs are associated with different CORESET pool index (e.g., coresetPoollndex) values (e.g., the two PUSCH being associated with different TRPs). Unlike other PUSCHs, the CORESET pool parameter (e.g., coresetPoollndex) may not be associated with determining Tx beam, power control parameters, and precoding for the Msg3 PUSCH or the MsgA PUSCH. That is, the Tx beam and the power control may be based on the PRACH, and the precoding may not be relevant because the Msg3 has a single layers and/or a single PUSCH port.

The determination of coresetPoollndex value associated with a PUSCH may be based on the coresetPoollndex value of the CORESET in which the DCI scheduling the PUSCH is detected. That is, the UE may identify the coresetPoollndex value of the CORESET that the DCI was received, and use the identified coresetPoollndex value as the coresetPoollndex value associated with the PUSCH. However, the random access message PUSCH (e.g., the Msg3 PUSCH or the MsgA PUSCH) is not associated with the coresetPoollndex value. Accordingly, the UE may be configured to obtain or determine the CORESET pool parameter (e.g., coresetPoollndex) associated with the Msg3 PUSCH or the MsgA PUSCH using various ways.

In one aspect, however, Msg3 is scheduled by a PDSCH RAR, not a DCI. That is, the Msg3 PUSCH is not scheduled with a DCI, and there is no CORESET nor coresetPoollndex value of the DCI to refer to. Therefore, the Msg3 PUSCH is not associated with the coresetPoollndex value to determine whether the Msg3 PUSCH may be transmitted with another PUSCH that is overlapping at least in part in the time domain. (e.g., FIG. 6C).

In another aspect, MsgA is scheduled by an RRC configurations (e.g., MsgA-PUSCH-Config-r16), and also not by a DCI. That is, the MsgA PUSCH is not scheduled with a DCI, and there is no CORESET nor coresetPoollndex value of the DCI to refer to. Here, the RACH occasion for the MsgA preamble may determine the parameters and/or the resources for MsgA PUSCH. Therefore, the Msg3 PUSCH is not associated with the coresetPoollndex value to determine whether the MsgA PUSCH may be transmitted with another PUSCH that is overlapping at least in part in the time domain.

In some aspects, the UE configured with multi-DCI based mTRP transmission may be further configured with two closed loop adjustment states, and may obtain or determine a closed loop index for a closed loop power control (CLPC) associated with the Msg3 PUSCH or the MsgA PUSCH. For example, the UE may be configured with multi-DCI based mTRP transmission (e.g., two coresetPoollndex values) and the first closed loop index (l=0) may be used for PUSCH transmissions toward the first TRP (e.g., coresetPoollndex value 0) and the second closed loop index (l=1) may be used for PUSCH transmissions toward the second TRP (e.g., coresetPoollndex value 1).

In one example, the closed loop index l for the Msg3 PUSCH or the MsgA PUSCH may be assumed to be 0 (e.g., first adjustment state), and the adjustment state may be reset to an initial value for the Msg3 PUSCH or the MsgA PUSCH transmission. However, if the closed loop index l for the Msg3 PUSCH or the MsgA PUSCH is assumed to be 0, when the PRACH is transmitted toward the second TRP, the closed loop index l may be reset for the first closed loop index (e.g., l=0), and the closed loop adjustment state may correspond to the first TRP. The adjustment state for the first TRP from the second TRP between the PRACH transmission and the Msg3 PUSCH or the MsgA PUSCH transmission may increase the complexity of the wireless communication without any benefit, or may unnecessarily reset a closed loop index associated with the other TRP, which in turn may cause degradation in the performance

In another example, the closed loop index l for the Msg3 PUSCH or the MsgA PUSCH may be configured so that the UE may reduce or avoid unnecessary reset of adjustment state and improve the efficiency of the multi-DCI based mTRP transmissions particularly when separate PRACH transmissions are transmitted toward different TRPs.

In some aspects, the UE may be configured with the multi-DCI based mTRP transmission with multiple TRPs. The UE may determine the associated coresetPoollndex value (e.g., associated SRS resource set) for a random access message PUSCH (e.g., the Msg3 PUSCH or the MsgA PUSCH), and determine whether another time-domain overlapping PUSCH may be transmitted simultaneously with the random access message PUSCH (e.g., the Msg3 PUSCH or the MsgA PUSCH). That is, the UE may be configured to obtain the coresetPoollndex value or the SRS resource set associated with the random access message PUSCH (e.g., the Msg3 PUSCH or the MsgA PUSCH), and determine whether the random access message PUSCH (e.g., the Msg3 PUSCH or the MsgA PUSCH) may be transmitted with another PUSCH that is scheduled to overlap with the random access message PUSCH (e.g., the Msg3 PUSCH or the MsgA PUSCH) at least in part in the time domain.

In one aspect, if the random access message PUSCH (e.g., the Msg3 PUSCH or the MsgA PUSCH) and the other PUSCH are associated with different coresetPoollndex values (e.g., different SRS resource sets), the UE may determine to transmit the random access message PUSCH (e.g., the Msg3 PUSCH or the MsgA PUSCH) and the other PUSCH.

In some aspects, if the random access message PUSCH (e.g., the Msg3 PUSCH or the MsgA PUSCH) and the other PUSCH are associated with the same coresetPoollndex values (e.g., the same SRS resource set), the UE may determine whether to refrain from transmitting both of the random access message PUSCH (e.g., the Msg3 PUSCH or the MsgA PUSCH) and the other PUSCH or transmit one of the random access message PUSCH (e.g., the Msg3 PUSCH or the MsgA PUSCH) and the other PUSCH.

In one aspect, based on determining that the random access message PUSCH (e.g., the Msg3 PUSCH or the MsgA PUSCH) and the other PUSCH are associated with the same coresetPoollndex values (e.g., the same SRS resource set), the UE may determine that this is an error case that may not be a proper configuration or scheduling. Accordingly, the UE may determine to disregard both of the random access message PUSCH (e.g., the Msg3 PUSCH or the MsgA PUSCH) and the other PUSCH associated with the same coresetPoollndex values (e.g., the same SRS resource set), and refrain from transmitting the random access message PUSCH (e.g., the Msg3 PUSCH or the MsgA PUSCH) and the other PUSCH.

In another aspect, based on determining that the random access message PUSCH (e.g., the Msg3 PUSCH or the MsgA PUSCH) and the other PUSCH are associated with the same coresetPoollndex values (e.g., the same SRS resource set), the UE may drop one of the random access message PUSCH (e.g., the Msg3 PUSCH or the MsgA PUSCH) or the other PUSCH (e.g., based on some priority rule). In one example, based on determining that the random access message PUSCH (e.g., the Msg3 PUSCH or the MsgA PUSCH) and the other PUSCH are associated with the same coresetPoollndex values (e.g., the same SRS resource set), the UE may be configured to transmit the random access message PUSCH (e.g., the Msg3 PUSCH or the MsgA PUSCH) and drop the other PUSCH. In another example, based on determining that the random access message PUSCH (e.g., the Msg3 PUSCH or the MsgA PUSCH) and the other PUSCH are associated with the same coresetPoollndex values (e.g., the same SRS resource set), the UE may be configured to drop one the random access message PUSCH (e.g., the Msg3 PUSCH or the MsgA PUSCH) and transmit the other PUSCH (e.g., based on some priority rule).

In some aspects, the UE may be configured to determine the coresetPoollndex value (e.g., the SRS resource set) associated with the random access message PUSCH (e.g., the Msg3 PUSCH or the MsgA PUSCH) based on various ways.

In one aspect, the UE may be configured to determine the coresetPoollndex value (e.g., the SRS resource set) associated with the random access message PUSCH (e.g., the Msg3 PUSCH) based on an indication in the RAR PDSCH. In case of the 4-step random access procedure, the coresetPoollndex value (e.g., the SRS resource set) associated with the random access message PUSCH (e.g., the Msg3 PUSCH) may be indicated in the Msg2 (e.g., the RAR PDSCH). For example, a reserved bit in the CSI request field of the RAR PDSCH may be used to indicate the coresetPoollndex value (e.g., the SRS resource set) associated with the random access message PUSCH (e.g., the Msg3 PUSCH).

In another aspect, the UE may be configured to determine the coresetPoollndex value (e.g., the SRS resource set) associated with the random access message PUSCH (e.g., the Msg3 PUSCH) based on an indication in a RAR PDCCH. The RAR PDCCH may refer to a DCI format 1_0 with the CRC scrambled with the RA-RNTI received from the network node within the RAR window. For example, a reserved bit in the DCI format 1_0 with CRC scrambled with RA-RNTI may be used to indicate the coresetPoollndex value (e.g., the SRS resource set) associated with the random access message PUSCH (e.g., the Msg3 PUSCH).

In another aspect, the UE may be configured to determine the coresetPoollndex value (e.g., the SRS resource set) associated with the random access message PUSCH (e.g., the Msg3 PUSCH) based on the coresetPoollndex value associated with the RAR PDCCH. That is, the RAR PDCCH received from the network node scheduling the RAR PDSCH (Msg2 payload) may have a CORESET in which the RAR PDCCH was received. The UE may refer to coresetPoollndex value associated with the CORESET in which the DCI format 1_0 with the CRC scrambled with the RA-RNTI was received from the network node, and use the coresetPoollndex value associated with the Msg2 PDCCH as the coresetPoollndex value (e.g., the SRS resource set) associated with the random access message PUSCH (e.g., the Msg3 PUSCH).

In another aspect, the UE may be configured to determine the coresetPoollndex value (e.g., the SRS resource set) associated with the random access message PUSCH (e.g., the Msg3 PUSCH or the MsgA PUSCH) as a default value (e.g., a fixed coresetPoollndex value). For example, the coresetPoollndex value (e.g., the SRS resource set) associated with the random access message PUSCH (e.g., the Msg3 PUSCH or the MsgA PUSCH) may be set to a value of 0.

In another aspect, the UE may be configured to determine the coresetPoollndex value (e.g., the SRS resource set) associated with the random access message PUSCH (e.g., the Msg3 PUSCH or the MsgA PUSCH) based on an indication in the PDCCH received from the network node that triggers the random-access procedure. That is, in case the random access procedure is triggered by an order DCI included in a PDCCH, the coresetPoollndex value (e.g., the SRS resource set) associated with the random access message PUSCH (e.g., the Msg3 PUSCH or the MsgA PUSCH) may be determined based on the PDCCH (order PDCCH) carrying the order DCI triggering the random access procedure. For example, the coresetPoollndex value associated with the CORESET that the order PDSCH was received from the network node may be determined as the coresetPoollndex value (e.g., the SRS resource set) associated with the random access message PUSCH (e.g., the Msg3 PUSCH or the MsgA PUSCH).

In another aspect, the UE may be configured to determine the coresetPoollndex value (e.g., the SRS resource set) associated with the random access message PUSCH (e.g., the Msg3 PUSCH or the MsgA PUSCH) based on the coresetPoollndex value associated with the PDCCH order DCI that triggers the random-access procedure. That is, in case the random access procedure is triggered by an order DCI included in a PDCCH, the coresetPoollndex value (e.g., the SRS resource set) associated with the random access message PUSCH (e.g., the Msg3 PUSCH or the MsgA PUSCH) may be determined based on the PDCCH (order PDCCH) carrying the order DCI triggering the random access procedure. For example, the order DCI triggering the random access procedure may include a bit indicating the coresetPoollndex value (e.g., the SRS resource set) associated with the random access message PUSCH (e.g., the Msg3 PUSCH or the MsgA PUSCH).

In another aspect, the UE may be configured to determine the coresetPoollndex value (e.g., the SRS resource set) associated with the random access message PUSCH (e.g., the Msg3 PUSCH or the MsgA PUSCH) based on the coresetPoollndex value associated with the corresponding SSB/CSI-RS associated with the random access message PUSCH transmission. Here, the SSB/CSI-RS may be used for beam control or the power control for the random access message PUSCH (e.g., the Msg3 PUSCH or the MsgA PUSCH) transmission, and each SSB/CSI-RS may be configured or associated with one CORESET group of the two CORESET groups corresponding to the two coresetPoollndex values. For example, the association of the each SSB/CSI-RS and the CORESET groups may be configured by an RRC configuration. Accordingly, based on the associated between the coresetPoollndex values and the SSBs/CSI-RSs, the UE may determine the coresetPoollndex value (e.g., the SRS resource set) associated with the SSB/CSI-RS associated with the random access message PUSCH transmission.

In another aspect, the UE may be configured to determine the coresetPoollndex value (e.g., the SRS resource set) associated with the random access message PUSCH (e.g., the Msg3 PUSCH or the MsgA PUSCH) based on the coresetPofolIndex value that is associated with a corresponding PRACH occasion or preamble transmitted to the network node before the corresponding random access message PUSCH (e.g., the Msg3 PUSCH or the MsgA PUSCH). That is, the UE may identify the coresetPoollndex value associated with the PRACH occasion or preamble transmitted to the network node, and determine the identified coresetPoollndex value associated with the PRACH occasion or preamble as the coresetPoollndex value (e.g., the SRS resource set) associated with the random access message PUSCH (e.g., the Msg3 PUSCH or the MsgA PUSCH).

In another aspect, the UE may be configured to determine the coresetPoollndex value (e.g., the SRS resource set) associated with the random access message PUSCH (e.g., the Msg3 PUSCH or the MsgA PUSCH) based on a physical cell identifier (ID) (PCI) associated with the serving cell corresponding to the transmission of the random access message. In case the two TRPs are associated with different cells and the UE is configured with an inter-cell mTRP transmission, each PCI of each serving cell may be associated with one coresetPoollndex value. Accordingly, the UE may refer to the service cell PCIs of the cells associated with the two TRPs to identify the coresetPoollndex value (e.g., the SRS resource set) associated with the random access message PUSCH (e.g., the Msg3 PUSCH or the MsgA PUSCH).

In some aspects, a UE configured with multi-DCI based mTRP transmission may determine to reset a closed loop adjustment state for transmitting the random access message PUSCH (e.g., the Msg3 PUSCH or the MsgA PUSCH) to a first closed loop adjustment state or a second closed loop adjustment state. Here, the two closed loops for PUSCH may be configured by the network node. (e.g., by a RRC configuration, twoPUSCH-PC-AdjustmentStates) Also, when a PUCCH is configured with two adjustment states (e.g., through the RRC configuration twoPUCCH-PC-AdjustmentStates), the determined closed loop index 1 of the PUSCH may be used to reset the closed loop adjustment state for the PUCCH corresponding to the same closed loop index 1. For example, the closed loop index value of 0 may represent the first closed loop index associated with the first TRP, and the closed loop index value of 1 may represent the second closed loop index associated with the second TRP. The UE may determine the closed loop index (e.g., 1=0 or 1) using various ways.

In one aspect, the closed loop index may be associated with the coresetPoollndex value. That is, the UE may first obtain the coresetPoollndex value associated with the Msg3 PUSCH or the MsgA PUSCH based on various ways, and then determine the closed loop index associated with based on the obtained coresetPoollndex value associated the Msg3 PUSCH or the MsgA PUSCH.

In one example, the UE may be configured to determine the coresetPoollndex value (e.g., the SRS resource set) associated with the random access message PUSCH (e.g., the Msg3 PUSCH) based on an indication in the RAR PDSCH. For example, in case of the 4-step random access procedure, a reserved bit in the CSI request field of the RAR PDSCH may be used to indicate the coresetPoollndex value (e.g., the SRS resource set) associated with the random access message PUSCH (e.g., the Msg3 PUSCH). The UE may configure the closed loop index based on the determined coresetPoollndex value (e.g., the SRS resource set) associated with the random access message PUSCH.

In another example, the UE may be configured to determine the coresetPoollndex value (e.g., the SRS resource set) associated with the random access message PUSCH (e.g., the Msg3 PUSCH) based on an indication in a RAR PDCCH. For example, in case of the 4-step random access procedure, a reserved bit in the DCI format 1_0 with CRC scrambled with RA-RNTI may be used to indicate the coresetPoollndex value (e.g., the SRS resource set) associated with the random access message PUSCH (e.g., the Msg3 PUSCH). The UE may configure the closed loop index based on the determined coresetPoollndex value (e.g., the SRS resource set) associated with the random access message PUSCH.

In another example, the UE may be configured to determine the coresetPoollndex value (e.g., the SRS resource set) associated with the random access message PUSCH (e.g., the Msg3 PUSCH) based on the coresetPoollndex value associated with the RAR PDCCH. The UE may use the coresetPoollndex value associated with the CORESET in which the DCI format 1_0 with the CRC scrambled with the RA-RNTI received from the network node as the coresetPoollndex value (e.g., the SRS resource set) associated with the random access message PUSCH (e.g., the Msg3 PUSCH). The UE may configure the closed loop index based on the determined coresetPoollndex value (e.g., the SRS resource set) associated with the random access message PUSCH.

In another example, the UE may be configured to determine the coresetPoollndex value (e.g., the SRS resource set) associated with the random access message PUSCH (e.g., the Msg3 PUSCH or the MsgA PUSCH) as a default value (e.g., a fixed coresetPoollndex value). For example, the coresetPoollndex value (e.g., the SRS resource set) associated with the random access message PUSCH (e.g., the Msg3 PUSCH or the MsgA PUSCH) may be set to a value of 0. The UE may configure the closed loop index based on the determined coresetPoollndex value (e.g., the SRS resource set) associated with the random access message PUSCH.

In another example, the UE may be configured to determine the coresetPoollndex value (e.g., the SRS resource set) associated with the random access message PUSCH (e.g., the Msg3 PUSCH or the MsgA PUSCH) based on an indication in the PDCCH received from the network node that triggers the random-access procedure. For example, the coresetPoollndex value associated with the CORESET that the order PDSCH was received from the network node may be determined as the coresetPoollndex value (e.g., the SRS resource set) associated with the random access message PUSCH (e.g., the Msg3 PUSCH or the MsgA PUSCH). The UE may configure the closed loop index based on the determined coresetPoollndex value (e.g., the SRS resource set) associated with the random access message PUSCH.

In another example, the UE may be configured to determine the coresetPoollndex value (e.g., the SRS resource set) associated with the random access message PUSCH (e.g., the Msg3 PUSCH or the MsgA PUSCH) based on the coresetPoollndex value associated with the PDCCH order DCI that triggers the random-access procedure. For example, the order DCI triggering the random access procedure may include a bit indicating the coresetPoollndex value (e.g., the SRS resource set) associated with the random access message PUSCH (e.g., the Msg3 PUSCH or the MsgA PUSCH). The UE may configure the closed loop index based on the determined coresetPoollndex value (e.g., the SRS resource set) associated with the random access message PUSCH.

In another example, the UE may be configured to determine the coresetPoollndex value (e.g., the SRS resource set) associated with the random access message PUSCH (e.g., the Msg3 PUSCH or the MsgA PUSCH) based on the coresetPoollndex value associated with the corresponding SSB/CSI-RS associated with the random access message PUSCH transmission. For example, the association of the each SSB/CSI-RS and the CORESET groups may be configured by an RRC configuration, and based on the associated between the coresetPoollndex values and the SSBs/CSI-RSs, the UE may determine the coresetPoollndex value (e.g., the SRS resource set) associated with the SSB/CSI-RS associated with the random access message PUSCH transmission. The UE may configure the closed loop index based on the determined coresetPoollndex value (e.g., the SRS resource set) associated with the random access message PUSCH.

In another example, the UE may be configured to determine the coresetPoollndex value (e.g., the SRS resource set) associated with the random access message PUSCH (e.g., the Msg3 PUSCH or the MsgA PUSCH) based on the coresetPoollndex value that is associated with a corresponding PRACH occasion or preamble transmitted to the network node before the corresponding random access message PUSCH (e.g., the Msg3 PUSCH or the MsgA PUSCH). The UE may configure the closed loop index based on the determined coresetPoollndex value (e.g., the SRS resource set) associated with the random access message PUSCH.

In another example, the UE may be configured to determine the coresetPoollndex value (e.g., the SRS resource set) associated with the random access message PUSCH (e.g., the Msg3 PUSCH or the MsgA PUSCH) based on a physical cell identifier (ID) (PCI) associated with the serving cell corresponding to the transmission of the random access message. In case the two TRPs are associated with different cells and the UE is configured with an inter-cell mTRP transmission, each PCI of each serving cell may be associated with one coresetPoollndex value, and the UE may refer to the service cell PCIs of the cells associated with the two TRPs to identify the coresetPoollndex value (e.g., the SRS resource set) associated with the random access message PUSCH (e.g., the Msg3 PUSCH or the MsgA PUSCH). The UE may configure the closed loop index based on the determined coresetPoollndex value (e.g., the SRS resource set) associated with the random access message PUSCH.

In another aspect, the closed loop index may be associated with the coresetPoollndex value. That is, the UE may first obtain the coresetPoollndex value associated with the Msg3 PUSCH or the MsgA PUSCH based on various ways, and then determine the closed loop index associated with based on the obtained coresetPoollndex value associated the Msg3 PUSCH or the MsgA PUSCH.

In some aspects, the UE may be configured to determine the closed loop index associated with the random access message PUSCH (e.g., the Msg3 PUSCH or the MsgA PUSCH) based on various ways.

In one example, the UE may be configured to determine the closed loop index associated with the random access message PUSCH (e.g., the Msg3 PUSCH) based on an indication in the RAR PDSCH. For example, in case of the 4-step random access procedure, a reserved bit in the CSI request field of the RAR PDSCH may be used to indicate the closed loop index associated with the random access message PUSCH (e.g., the Msg3 PUSCH).

In another example, the UE may be configured to determine the closed loop index associated with the random access message PUSCH (e.g., the Msg3 PUSCH) based on an indication in a RAR PDCCH. For example, in case of the 4-step random access procedure, a reserved bit in the DCI format 1_0 with CRC scrambled with RA-RNTI may be used to indicate the closed loop index associated with the random access message PUSCH (e.g., the Msg3 PUSCH).

In another example, the UE may be configured to determine the closed loop index associated with the random access message PUSCH (e.g., the Msg3 PUSCH) based on the coresetPoollndex value associated with the RAR PDCCH. The UE may use the coresetPoollndex value associated with the CORESET in which the DCI format 1_0 with the CRC scrambled with the RA-RNTI received from the network node as the closed loop index associated with the random access message PUSCH (e.g., the Msg3 PUSCH).

In another example, the UE may be configured to determine the closed loop index associated with the random access message PUSCH (e.g., the Msg3 PUSCH or the MsgA PUSCH) as a default value (e.g., a fixed closed loop index value). For example, the closed loop index associated with the random access message PUSCH (e.g., the Msg3 PUSCH or the MsgA PUSCH) may be set to a value of 0.

In another example, the UE may be configured to determine the closed loop index associated with the random access message PUSCH (e.g., the Msg3 PUSCH or the MsgA PUSCH) based on an indication in the PDCCH received from the network node that triggers the random-access procedure. For example, the coresetPoollndex value associated with the CORESET that the order PDSCH was received from the network node may be determined as the closed loop index associated with the random access message PUSCH (e.g., the Msg3 PUSCH or the MsgA PUSCH).

In another example, the UE may be configured to determine the closed loop index associated with the random access message PUSCH (e.g., the Msg3 PUSCH or the MsgA PUSCH) based on the coresetPoollndex value associated with the PDCCH order DCI that triggers the random-access procedure. For example, the order DCI triggering the random access procedure may include a bit indicating the closed loop index associated with the random access message PUSCH (e.g., the Msg3 PUSCH or the MsgA PUSCH).

In another example, the UE may be configured to determine the closed loop index associated with the random access message PUSCH (e.g., the Msg3 PUSCH or the MsgA PUSCH) based on the coresetPoollndex value associated with the corresponding SSB/CSI-RS associated with the random access message PUSCH transmission. For example, the association of the each SSB/CSI-RS and the CORESET groups may be configured by an RRC configuration, and based on the associated between the coresetPoollndex values and the SSBs/CSI-RSs, the UE may determine the closed loop index associated with the SSB/CSI-RS associated with the random access message PUSCH transmission.

In another example, the UE may be configured to determine the closed loop index associated with the random access message PUSCH (e.g., the Msg3 PUSCH or the MsgA PUSCH) based on the coresetPoollndex value that is associated with a corresponding PRACH occasion or preamble transmitted to the network node before the corresponding random access message PUSCH (e.g., the Msg3 PUSCH or the MsgA PUSCH).

In another example, the UE may be configured to determine the closed loop index associated with the random access message PUSCH (e.g., the Msg3 PUSCH or the MsgA PUSCH) based on a physical cell identifier (ID) (PCI) associated with the serving cell corresponding to the transmission of the random access message. In case the two TRPs are associated with different cells and the UE is configured with an inter-cell mTRP transmission, each PCI of each serving cell may be associated with one coresetPoollndex value, and the UE may refer to the service cell PCIs of the cells associated with the two TRPs to identify the closed loop index associated with the random access message PUSCH (e.g., the Msg3 PUSCH or the MsgA PUSCH).

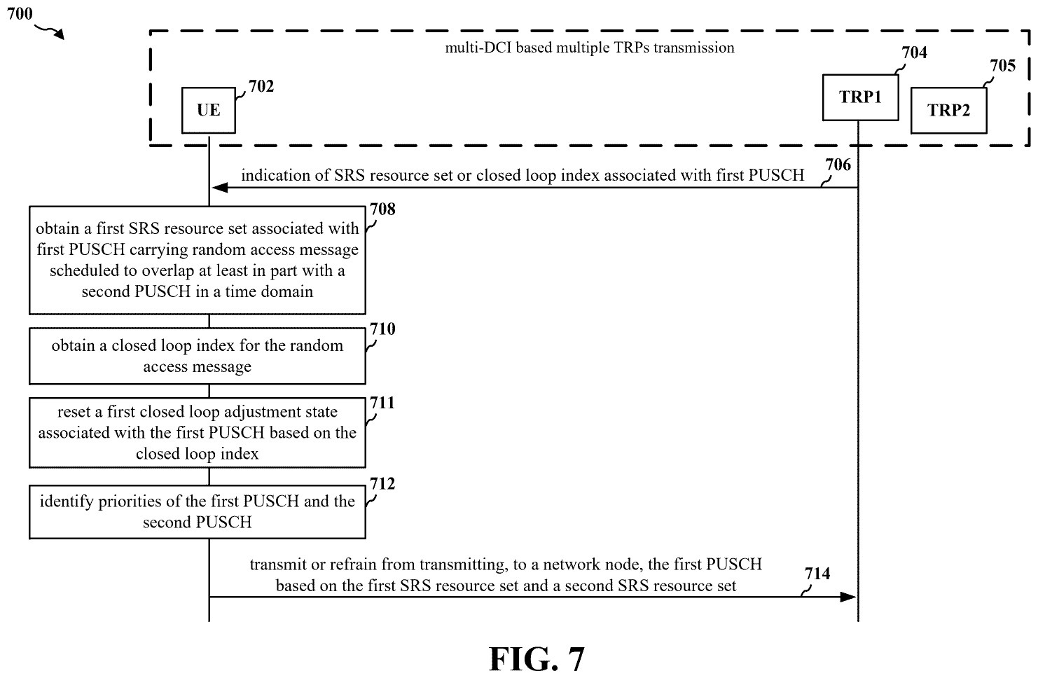

FIG. 7 is a call-flow diagram 700 of a method of wireless communication. The call-flow diagram 700 may include a UE 702, a first network node, and a second network node. Here, the first network node may be a first TRP 704 and the second network node may be a second TRP 705, and the UE 702 and the first TRP 704 and the second TRP 705 may be configured with a multi-DCI based mTRP transmission. The UE 702 may be configured to obtain a SRS resource set (e.g., the coresetPoollndex value) associated with a PUSCH carrying a random access message. The UE 702 may manage the transmission of the PUSCH based on the obtained SRS resource set.

At 706, the first TRP 704 may transmit, for the UE 702, an indication of at least one of a first SRS resource set or a closed loop index associated with a first PUSCH carrying a random access message to be transmitted to the first TRP 704, the first PUSCH being scheduled to overlap at least in part with a second PUSCH in a time domain. The UE 702 may receive, from the first TRP 704, an indication of at least one of a first SRS resource set or a closed loop index associated with a first PUSCH carrying a random access message to be transmitted by the UE 702, the first PUSCH being scheduled to overlap at least in part with a second PUSCH in a time domain. In one example, the indication of the first SRS resource set associated with the first PUSCH carrying the random access message may include at least one of a random access response PDSCH, a random access response PDCCH, or a parameter associated with the random access response PDCCH. In another example, the indication of the first SRS resource set associated with the first PUSCH carrying the random access message may be transmitted via a PDCCH including an order to initiate a random access procedure, and the indication may include at least one of the PDCCH including the order to initiate the random access procedure, or a parameter associated with the PDCCH including the order to initiate the random access procedure. In another example, the indication of the first SRS resource set associated with the first PUSCH carrying the random access message may include at least one of a parameter associated with at least one of a SSB or a CSI-RS corresponding with the random access message, the parameter associated with PRACH occasion or preamble transmitted to the first TRP 704, or a PCI of a service cell on which the first PUSCH is scheduled.

At 708, the UE 702 may obtain a first SRS resource set associated with a first PUSCH carrying a random access message to be transmitted to a first TRP 704, the first PUSCH being scheduled to overlap at least in part with a second PUSCH in a time domain. For example, the UE 702 may obtain a coresetPoollndex value associated with the first PUSCH carrying the random access message to be transmitted to the first TRP 704.

In one aspect, the first PUSCH carrying the random access message may be scheduled in response to a random access response, and the first SRS resource set may be obtained based on at least one of a random access response PDSCH, a random access response PDCCH, or a parameter associated with the random access response PDCCH.

In one example, the UE 702 may be configured to determine the coresetPoollndex value (e.g., the SRS resource set) associated with the random access message PUSCH (e.g., the Msg3 PUSCH) based on an indication in the RAR PDSCH. In case of the 4-step random access procedure, the coresetPoollndex value (e.g., the SRS resource set) associated with the random access message PUSCH (e.g., the Msg3 PUSCH) may be indicated in the Msg2 (e.g., the RAR PDSCH). For example, a reserved bit in the CSI request field of the RAR PDSCH may be used to indicate the coresetPoollndex value (e.g., the SRS resource set) associated with the random access message PUSCH (e.g., the Msg3 PUSCH).

In another example, the UE 702 may be configured to determine the coresetPoollndex value (e.g., the SRS resource set) associated with the random access message PUSCH (e.g., the Msg3 PUSCH) based on an indication in a RAR PDCCH. The RAR PDCCH may refer to a DCI format 1_0 with the CRC scrambled with the RA-RNTI received from the first TRP 704 within the RAR window. For example, a reserved bit in the DCI format 1_0 with CRC scrambled with RA-RNTI may be used to indicate the coresetPoollndex value (e.g., the SRS resource set) associated with the random access message PUSCH (e.g., the Msg3 PUSCH).

In another example, the UE 702 may be configured to determine the coresetPoollndex value (e.g., the SRS resource set) associated with the random access message PUSCH (e.g., the Msg3 PUSCH) based on the coresetPoollndex value associated with the RAR PDCCH. That is, the RAR PDCCH received from the first TRP 704 scheduling the RAR PDSCH (Msg2 payload) may have a CORESET in which the RAR PDCCH was received. The UE 702 may refer to coresetPoollndex value associated with the CORESET in which the DCI format 1_0 with the CRC scrambled with the RA-RNTI was received from the first TRP 704, and use the coresetPoollndex value associated with the Msg2 PDSCH as the coresetPoollndex value (e.g., the SRS resource set) associated with the random access message PUSCH (e.g., the Msg3 PUSCH).

In another aspect, the first SRS resource set associated with the first PUSCH carrying the random access message may be a default value configured for the UE 702. The UE 702 may be configured to determine the coresetPoollndex value (e.g., the SRS resource set) associated with the random access message PUSCH (e.g., the Msg3 PUSCH or the MsgA PUSCH) as a default value (e.g., a fixed coresetPoollndex value). For example, the coresetPoollndex value (e.g., the SRS resource set) associated with the random access message PUSCH (e.g., the Msg3 PUSCH or the MsgA PUSCH) may be set to a value of 0.

In another aspect, the UE 702 may receive a PDCCH including an order to initiate a random access procedure at 706, and the first PUSCH carrying the random access message may be scheduled in response to the PDCCH including the order to initiate the random access procedure. The first SRS resource set may be obtained based on at least one of the PDCCH including the order to initiate the random access procedure, or a parameter associated with the PDCCH including the order to initiate the random access procedure.

In one example, the UE 702 may be configured to determine the coresetPoollndex value (e.g., the SRS resource set) associated with the random access message PUSCH (e.g., the Msg3 PUSCH or the MsgA PUSCH) based on an indication in the PDCCH received from the first TRP 704 that triggers the random-access procedure. That is, in case the random access procedure is triggered by an order DCI included in a PDCCH, the coresetPoollndex value (e.g., the SRS resource set) associated with the random access message PUSCH (e.g., the Msg3 PUSCH or the MsgA PUSCH) may be determined based on the PDCCH (order PDCCH) carrying the order DCI triggering the random access procedure. For example, the coresetPoollndex value associated with the CORESET that the order PDSCH was received from the first TRP 704 may be determined as the coresetPoollndex value (e.g., the SRS resource set) associated with the random access message PUSCH (e.g., the Msg3 PUSCH or the MsgA PUSCH).

In another example, the UE 702 may be configured to determine the coresetPoollndex value (e.g., the SRS resource set) associated with the random access message PUSCH (e.g., the Msg3 PUSCH or the MsgA PUSCH) based on the coresetPoollndex value associated with the PDCCH order DCI that triggers the random-access procedure. That is, in case the random access procedure is triggered by an order DCI included in a PDCCH, the coresetPoollndex value (e.g., the SRS resource set) associated with the random access message PUSCH (e.g., the Msg3 PUSCH or the MsgA PUSCH) may be determined based on the PDCCH (order PDCCH) carrying the order DCI triggering the random access procedure. For example, the order DCI triggering the random access procedure may include a bit indicating the coresetPoollndex value (e.g., the SRS resource set) associated with the random access message PUSCH (e.g., the Msg3 PUSCH or the MsgA PUSCH).

In another aspect, the first SRS resource set may be obtained based on at least one of a parameter associated with at least one of a SSB or a CSI-RS corresponding with the random access message, the parameter associated with PRACH occasion or preamble transmitted to the first TRP 704, or a PCI of a service cell on which the first PUSCH is scheduled.

In one example, the UE 702 may be configured to determine the coresetPoollndex value (e.g., the SRS resource set) associated with the random access message PUSCH (e.g., the Msg3 PUSCH or the MsgA PUSCH) based on the coresetPoollndex value associated with the corresponding SSB/CSI-RS associated with the random access message PUSCH transmission. Here, the SSB/CSI-RS may be used for beam control or the power control for the random access message PUSCH (e.g., the Msg3 PUSCH or the MsgA PUSCH) transmission, and each SSB/CSI-RS may be configured or associated with one CORESET group of the two CORESET groups corresponding to the two coresetPoollndex values. For example, the association of the each SSB/CSI-RS and the CORESET groups may be configured by an RRC configuration. Accordingly, based on the associated between the coresetPoollndex values and the SSBs/CSI-RSs, the UE 702 may determine the coresetPoollndex value (e.g., the SRS resource set) associated with the SSB/CSI-RS associated with the random access message PUSCH transmission.

In another example, the UE 702 may be configured to determine the coresetPoollndex value (e.g., the SRS resource set) associated with the random access message PUSCH (e.g., the Msg3 PUSCH or the MsgA PUSCH) based on the coresetPoollndex value that is associated with a corresponding PRACH occasion or preamble transmitted to the first TRP 704 before the corresponding random access message PUSCH (e.g., the Msg3 PUSCH or the MsgA PUSCH). That is, the UE 702 may identify the coresetPoollndex value associated with the PRACH occasion or preamble transmitted to the first TRP 704, and determine the identified coresetPoollndex value associated with the PRACH occasion or preamble as the coresetPoollndex value (e.g., the SRS resource set) associated with the random access message PUSCH (e.g., the Msg3 PUSCH or the MsgA PUSCH).

In another example, the UE 702 may be configured to determine the coresetPoollndex value (e.g., the SRS resource set) associated with the random access message PUSCH (e.g., the Msg3 PUSCH or the MsgA PUSCH) based on a physical cell identifier (ID) (PCI) associated with the serving cell corresponding to the transmission of the random access message. In case the two TRPs are associated with different cells and the UE 702 is configured with an inter-cell mTRP transmission, each PCI of each serving cell may be associated with one coresetPoollndex value. Accordingly, the UE 702 may refer to the service cell PCIs of the cells associated with the two TRPs to identify the coresetPoollndex value (e.g., the SRS resource set) associated with the random access message PUSCH (e.g., the Msg3 PUSCH or the MsgA PUSCH).

At 710, the UE 702 may obtain a closed loop index for the random access message. That is, the UE 702 configured with multi-DCI based mTRP transmission may determine to reset a closed loop adjustment state for transmitting the random access message PUSCH (e.g., the Msg3 PUSCH or the MsgA PUSCH) to a first closed loop adjustment state or a second closed loop adjustment state. The closed loop index may indicate that a first closed loop adjustment state from the first closed loop adjustment state and a second closed loop adjustment state is to be reset. Here, the two closed loops for PUSCH may be configured by the first TRP 704. (e.g., by a RRC configuration, twoPUSCH-PC-AdjustmentStates) Also, when a PUCCH is configured with two adjustment states (e.g., through the RRC configuration twoPUCCH-PC-AdjustmentStates), the determined closed loop index 1 of the PUSCH may be used to reset the closed loop adjustment state for the PUCCH corresponding to the same closed loop index 1. For example, the closed loop index value of 0 may represent the first closed loop index associated with the first TRP 704, and the closed loop index value of 1 may represent the second closed loop index associated with the second TRP 705. The UE 702 may determine the closed loop index (e.g., 1=0 or 1) using various ways.

In one aspect, closed loop index for the first PUSCH carrying the random access message may be associated with the SRS resource set associated with the random access message as obtained at 708. That is, the UE 702 may first obtain the coresetPoollndex value associated with the Msg3 PUSCH or the MsgA PUSCH based on various ways at 708, and then determine the closed loop index associated with based on the obtained coresetPoollndex value associated the Msg3 PUSCH or the MsgA PUSCH.

In another aspect, the first PUSCH carrying the random access message may be scheduled in response to a random access response received at 706, and the closed loop index may be obtained based on at least one of a random access response PDSCH, a random access response PDCCH, or a parameter associated with the random access response PDCCH.

In one example, the UE 702 may be configured to determine the closed loop index associated with the random access message PUSCH (e.g., the Msg3 PUSCH) based on an indication in the RAR PDSCH. For example, in case of the 4-step random access procedure, a reserved bit in the CSI request field of the RAR PDSCH may be used to indicate the closed loop index associated with the random access message PUSCH (e.g., the Msg3 PUSCH).

In another example, the UE 702 may be configured to determine the closed loop index associated with the random access message PUSCH (e.g., the Msg3 PUSCH) based on an indication in a RAR PDCCH. For example, in case of the 4-step random access procedure, a reserved bit in the DCI format 1_0 with CRC scrambled with RA-RNTI may be used to indicate the closed loop index associated with the random access message PUSCH (e.g., the Msg3 PUSCH).

In another example, the UE 702 may be configured to determine the closed loop index associated with the random access message PUSCH (e.g., the Msg3 PUSCH) based on the coresetPoollndex value associated with the RAR PDCCH. The UE 702 may use the coresetPoollndex value associated with the CORESET in which the DCI format 1_0 with the CRC scrambled with the RA-RNTI received from the first TRP 704 as the closed loop index associated with the random access message PUSCH (e.g., the Msg3 PUSCH).

In another aspect, the closed loop index associated with the first PUSCH carrying the random access message may be a default value configured for the UE 702. That is, the UE 702 may be configured to determine the closed loop index associated with the random access message PUSCH (e.g., the Msg3 PUSCH or the MsgA PUSCH) as a default value (e.g., a fixed closed loop index value). For example, the closed loop index associated with the random access message PUSCH (e.g., the Msg3 PUSCH or the MsgA PUSCH) may be set to a value of 0.

In another aspect, the UE 702 may receive a PDCCH including an order to initiate a random access procedure at 706, and the first PUSCH carrying the random access message may be scheduled in response to the PDCCH including the order to initiate the random access procedure. The closed loop index may be obtained based on at least one of the PDCCH including the order to initiate the random access procedure, or a parameter associated with the PDCCH including the order to initiate the random access procedure.

In one example, the UE 702 may be configured to determine the closed loop index associated with the random access message PUSCH (e.g., the Msg3 PUSCH or the MsgA PUSCH) based on an indication in the PDCCH received from the first TRP 704 that triggers the random-access procedure. For example, the coresetPoollndex value associated with the CORESET that the order PDSCH was received from the first TRP 704 may be determined as the closed loop index associated with the random access message PUSCH (e.g., the Msg3 PUSCH or the MsgA PUSCH).

In another example, the UE 702 may be configured to determine the closed loop index associated with the random access message PUSCH (e.g., the Msg3 PUSCH or the MsgA PUSCH) based on the coresetPoollndex value associated with the PDCCH order DCI that triggers the random-access procedure. For example, the order DCI triggering the random access procedure may include a bit indicating the closed loop index associated with the random access message PUSCH (e.g., the Msg3 PUSCH or the MsgA PUSCH).

In another aspect, the closed loop index may be obtained based on at least one of a parameter associated with at least one of a SSB or a CSI-RS corresponding with the random access message, the parameter associated with PRACH occasion or preamble transmitted to the first TRP 704, or a PCI of a service cell on which the first PUSCH is scheduled.

In one example, the UE 702 may be configured to determine the closed loop index associated with the random access message PUSCH (e.g., the Msg3 PUSCH or the MsgA PUSCH) based on the coresetPoollndex value associated with the corresponding SSB/CSI-RS associated with the random access message PUSCH transmission. For example, the association of the each SSB/CSI-RS and the CORESET groups may be configured by an RRC configuration, and based on the associated between the coresetPoollndex values and the SSBs/CSI-RSs, the UE 702 may determine the closed loop index associated with the SSB/CSI-RS associated with the random access message PUSCH transmission.

In another example, the UE 702 may be configured to determine the closed loop index associated with the random access message PUSCH (e.g., the Msg3 PUSCH or the MsgA PUSCH) based on the coresetPoollndex value that is associated with a corresponding PRACH occasion or preamble transmitted to the first TRP 704 before the corresponding random access message PUSCH (e.g., the Msg3 PUSCH or the MsgA PUSCH).

In another example, the UE 702 may be configured to determine the closed loop index associated with the random access message PUSCH (e.g., the Msg3 PUSCH or the MsgA PUSCH) based on a physical cell identifier (ID) (PCI) associated with the serving cell corresponding to the transmission of the random access message. In case the two TRPs are associated with different cells and the UE 702 is configured with an inter-cell mTRP transmission, each PCI of each serving cell may be associated with one coresetPoollndex value, and the UE 702 may refer to the service cell PCIs of the cells associated with the two TRPs to identify the closed loop index associated with the random access message PUSCH (e.g., the Msg3 PUSCH or the MsgA PUSCH).

At 711, the UE 702 may reset a first closed loop adjustment state associated with the first PUSCH carrying the random access message based on the closed loop index. That is, the UE 702 may reset the first closed loop adjustment state associated with the first PUSCH carrying the random access message when resetting the first closed loop adjustment state associated with the first PUSCH carrying the random access message corresponds with the first TRP 704 and reduce or avoid unnecessary reset of adjustment state and improve the efficiency of the multi-DCI based mTRP transmissions.

At 712, the UE 702 may identify priorities of the first PUSCH and the second PUSCH. In one aspect, the one of the first PUSCH and the second PUSCH transmitted to the first TRP 704 has a higher priority, and an other one of the first PUSCH or the second PUSCH refrained from transmitting to the first TRP 704 has a lower priority. In one example, the random access message PUSCH (e.g., the Msg3 PUSCH or the MsgA PUSCH) may have a higher priority than the other PUSCH, and based on determining that the random access message PUSCH (e.g., the Msg3 PUSCH or the MsgA PUSCH) and the other PUSCH are associated with the same coresetPoollndex values (e.g., the same SRS resource set), the UE 702 may transmit the random access message PUSCH (e.g., the Msg3 PUSCH or the MsgA PUSCH) and drop the other PUSCH at 714. In another example, the random access message PUSCH (e.g., the Msg3 PUSCH or the MsgA PUSCH) may have a lower priority than the other PUSCH, and based on determining that the random access message PUSCH (e.g., the Msg3 PUSCH or the MsgA PUSCH) and the other PUSCH are associated with the same coresetPoollndex values (e.g., the same SRS resource set), the UE 702 may drop the random access message PUSCH (e.g., the Msg3 PUSCH or the MsgA PUSCH) and transmit the other PUSCH (e.g., based on some priority rule) at 714.

At 714, the UE 702 may transmit or refrain from transmitting, to a first TRP 704, the first PUSCH based on the first SRS resource set and a second SRS resource set associated with the second PUSCH. The UE 702 may also transmit, to the first TRP 704, the first PUSCH carrying the random access message based on the closed loop index. The first TRP 704 may receive at least one of the first PUSCH or the second PUSCH based on the first SRS resource set and a second SRS resource set associated with the second PUSCH. The first TRP 704 may receive the first PUSCH carrying the random access message based on the closed loop index.

In some aspects, the first PUSCH carrying the random access message may be transmitted based on the first SRS resource set and a second SRS resource set associated with the second PUSCH. That is, the UE 702 may determine or obtain the associated coresetPoollndex value (e.g., associated SRS resource set) for a random access message PUSCH (e.g., the Msg3 PUSCH or the MsgA PUSCH) at 708, and determine whether another time-domain overlapping PUSCH may be transmitted simultaneously with the random access message PUSCH (e.g., the Msg3 PUSCH or the MsgA PUSCH).

In one example, the UE 702 may transmit the first PUSCH and the second PUSCH overlapping at least in part in the time domain based on the first SRS resource set obtained at 708 being different from the second SRS resource set. That is, if the random access message PUSCH (e.g., the Msg3 PUSCH or the MsgA PUSCH) and the other PUSCH are associated with different coresetPoollndex values (e.g., different SRS resource sets), the UE 702 may determine to transmit the random access message PUSCH (e.g., the Msg3 PUSCH or the MsgA PUSCH) and the other PUSCH.

If the random access message PUSCH (e.g., the Msg3 PUSCH or the MsgA PUSCH) and the other PUSCH are associated with the same coresetPoollndex values (e.g., the same SRS resource set), the UE 702 may determine whether to refrain from transmitting both of the random access message PUSCH (e.g., the Msg3 PUSCH or the MsgA PUSCH) and the other PUSCH or transmit one of the random access message PUSCH (e.g., the Msg3 PUSCH or the MsgA PUSCH) and the other PUSCH.

In one example, the UE 702 may dismiss the first PUSCH and the second PUSCH based on the first SRS resource set obtained at 708 being same as the second SRS resource set. Based on determining that the random access message PUSCH (e.g., the Msg3 PUSCH or the MsgA PUSCH) and the other PUSCH are associated with the same coresetPoollndex values (e.g., the same SRS resource set), the UE 702 may determine that this is an error case that may not be a proper configuration or scheduling. Accordingly, the UE 702 may determine to disregard both of the random access message PUSCH (e.g., the Msg3 PUSCH or the MsgA PUSCH) and the other PUSCH associated with the same coresetPoollndex values (e.g., the same SRS resource set), and refrain from transmitting the random access message PUSCH (e.g., the Msg3 PUSCH or the MsgA PUSCH) and the other PUSCH.

In another example, the UE 702 may transmit, to the first TRP 704, one of the first PUSCH or the second PUSCH and refrain from transmitting an other one of the first PUSCH or the second PUSCH based on the first SRS resource set obtained at 708 being same as the second SRS resource set. Based on determining that the random access message PUSCH (e.g., the Msg3 PUSCH or the MsgA PUSCH) and the other PUSCH are associated with the same coresetPoollndex values (e.g., the same SRS resource set), the UE 702 may drop one of the random access message PUSCH (e.g., the Msg3 PUSCH or the MsgA PUSCH) or the other PUSCH (e.g., based on some priority rule). For example, based on determining that the random access message PUSCH (e.g., the Msg3 PUSCH or the MsgA PUSCH) and the other PUSCH are associated with the same coresetPoollndex values (e.g., the same SRS resource set), the UE 702 may be configured to transmit the random access message PUSCH (e.g., the Msg3 PUSCH or the MsgA PUSCH) and drop the other PUSCH. For example, based on determining that the random access message PUSCH (e.g., the Msg3 PUSCH or the MsgA PUSCH) and the other PUSCH are associated with the same coresetPoollndex values (e.g., the same SRS resource set), the UE 702 may be configured to drop one the random access message PUSCH (e.g., the Msg3 PUSCH or the MsgA PUSCH) and transmit the other PUSCH (e.g., based on some priority rule).

In some aspects, the first PUSCH carrying the random access message may be transmitted based on the closed loop index obtained at 710. When a PUCCH is configured with two adjustment states (e.g., through the RRC configuration twoPUCCH-PC-AdjustmentStates), the determined closed loop index 1 of the PUSCH may be used to reset the closed loop adjustment state for the PUCCH corresponding to the same closed loop index 1. For example, the closed loop index value of 0 may represent the first closed loop index associated with the first TRP 704, and the closed loop index value of 1 may represent the second closed loop index associated with the second TRP 705.

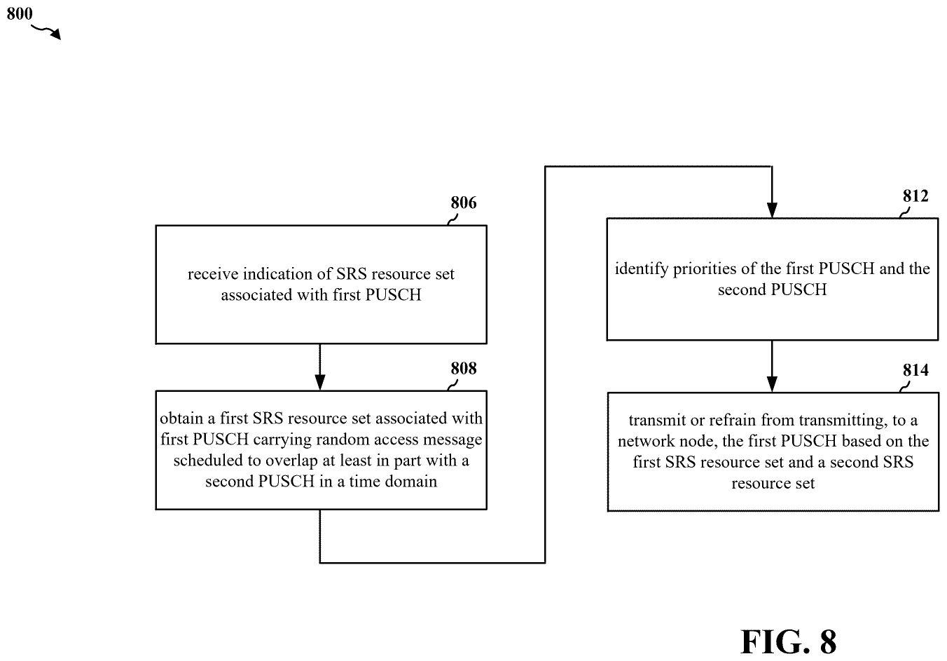

FIG. 8 is a flowchart 800 of a method of wireless communication. The method may be performed by a UE (e.g., the UE 104/602; the apparatus 1404). The UE may be configured with a multi-DCI based mTRP transmission with a first TRP and a second TRP. The UE may be configured to obtain a SRS resource set (e.g., the coresetPoollndex value) associated with a PUSCH carrying a random access message. The UE may manage the transmission of the PUSCH based on the obtained SRS resource set.

At 806, the UE may receive, from the network node, an indication of a first SRS resource set associated with a first PUSCH carrying a random access message to be transmitted to the first TRP, the first PUSCH being scheduled to overlap at least in part with a second PUSCH in a time domain. In one example, the indication of the first SRS resource set associated with the first PUSCH carrying the random access message may include at least one of a random access response PDSCH, a random access response PDCCH, or a parameter associated with the random access response PDCCH. In another example, the indication of the first SRS resource set associated with the first PUSCH carrying the random access message may be transmitted via a PDCCH including an order to initiate a random access procedure, and the indication may include at least one of the PDCCH including the order to initiate the random access procedure, or a parameter associated with the PDCCH including the order to initiate the random access procedure. In another example, the indication of the first SRS resource set associated with the first PUSCH carrying the random access message may include at least one of a parameter associated with at least one of a SSB or a CSI-RS corresponding with the random access message, the parameter associated with PRACH occasion or preamble transmitted to the first TRP, or a PCI of a service cell on which the first PUSCH is scheduled. For example, at 706, the UE 702 may receive, from the first TRP 704, an indication of at least one of a first SRS resource set or a closed loop index associated with a first PUSCH carrying a random access message to be transmitted to the first TRP 704, the first PUSCH being scheduled to overlap at least in part with a second PUSCH in a time domain. Furthermore, 806 may be performed by an mTRP RACH configuration component 198.

At 808, the UE may obtain a first SRS resource set associated with a first PUSCH carrying a random access message to be transmitted to a first TRP, the first PUSCH being scheduled to overlap at least in part with a second PUSCH in a time domain. The UE may obtain a coresetPoollndex value associated with the first PUSCH carrying the random access message to be transmitted to the first TRP. For example, at 708, the UE 702 may obtain a first SRS resource set associated with a first PUSCH carrying a random access message to be transmitted to a first TRP 704, the first PUSCH being scheduled to overlap at least in part with a second PUSCH in a time domain. Furthermore, 808 may be performed by the mTRP RACH configuration component 198.

In one aspect, the first PUSCH carrying the random access message may be scheduled in response to a random access response, and the first SRS resource set may be obtained based on at least one of a random access response PDSCH, a random access response PDCCH, or a parameter associated with the random access response PDCCH.

In one example, the UE may be configured to determine the coresetPoollndex value (e.g., the SRS resource set) associated with the random access message PUSCH (e.g., the Msg3 PUSCH) based on an indication in the RAR PDSCH. In case of the 4-step random access procedure, the coresetPoollndex value (e.g., the SRS resource set) associated with the random access message PUSCH (e.g., the Msg3 PUSCH) may be indicated in the Msg2 (e.g., the RAR PDSCH). For example, a reserved bit in the CSI request field of the RAR PDSCH may be used to indicate the coresetPoollndex value (e.g., the SRS resource set) associated with the random access message PUSCH (e.g., the Msg3 PUSCH).

In another example, the UE may be configured to determine the coresetPoollndex value (e.g., the SRS resource set) associated with the random access message PUSCH (e.g., the Msg3 PUSCH) based on an indication in a RAR PDCCH. The RAR PDCCH may refer to a DCI format 1_0 with the CRC scrambled with the RA-RNTI received from the first TRP within the RAR window. For example, a reserved bit in the DCI format 1_0 with CRC scrambled with RA-RNTI may be used to indicate the coresetPoollndex value (e.g., the SRS resource set) associated with the random access message PUSCH (e.g., the Msg3 PUSCH).

In another example, the UE may be configured to determine the coresetPoollndex value (e.g., the SRS resource set) associated with the random access message PUSCH (e.g., the Msg3 PUSCH) based on the coresetPoollndex value associated with the RAR PDCCH. That is, the RAR PDCCH received from the first TRP scheduling the RAR PDSCH (Msg2 payload) may have a CORESET in which the RAR PDCCH was received. The UE may refer to coresetPoollndex value associated with the CORESET in which the DCI format 1_0 with the CRC scrambled with the RA-RNTI was received from the first TRP, and use the coresetPoollndex value associated with the Msg2 PDSCH as the coresetPoollndex value (e.g., the SRS resource set) associated with the random access message PUSCH (e.g., the Msg3 PUSCH).

In another aspect, the first SRS resource set associated with the first PUSCH carrying the random access message may be a default value configured for the UE. The UE may be configured to determine the coresetPoollndex value (e.g., the SRS resource set) associated with the random access message PUSCH (e.g., the Msg3 PUSCH or the MsgA PUSCH) as a default value (e.g., a fixed coresetPoollndex value). For example, the coresetPoollndex value (e.g., the SRS resource set) associated with the random access message PUSCH (e.g., the Msg3 PUSCH or the MsgA PUSCH) may be set to a value of 0.

In another aspect, the UE may receive a PDCCH including an order to initiate a random access procedure at 806, and the first PUSCH carrying the random access message may be scheduled in response to the PDCCH including the order to initiate the random access procedure. The first SRS resource set may be obtained based on at least one of the PDCCH including the order to initiate the random access procedure, or a parameter associated with the PDCCH including the order to initiate the random access procedure.

In one example, the UE may be configured to determine the coresetPoollndex value (e.g., the SRS resource set) associated with the random access message PUSCH (e.g., the Msg3 PUSCH or the MsgA PUSCH) based on an indication in the PDCCH received from the first TRP that triggers the random-access procedure. That is, in case the random access procedure is triggered by an order DCI included in a PDCCH, the coresetPoollndex value (e.g., the SRS resource set) associated with the random access message PUSCH (e.g., the Msg3 PUSCH or the MsgA PUSCH) may be determined based on the PDCCH (order PDCCH) carrying the order DCI triggering the random access procedure. For example, the coresetPoollndex value associated with the CORESET that the order PDSCH was received from the first TRP may be determined as the coresetPoollndex value (e.g., the SRS resource set) associated with the random access message PUSCH (e.g., the Msg3 PUSCH or the MsgA PUSCH).

In another example, the UE may be configured to determine the coresetPoollndex value (e.g., the SRS resource set) associated with the random access message PUSCH (e.g., the Msg3 PUSCH or the MsgA PUSCH) based on the coresetPoollndex value associated with the PDCCH order DCI that triggers the random-access procedure. That is, in case the random access procedure is triggered by an order DCI included in a PDCCH, the coresetPoollndex value (e.g., the SRS resource set) associated with the random access message PUSCH (e.g., the Msg3 PUSCH or the MsgA PUSCH) may be determined based on the PDCCH (order PDCCH) carrying the order DCI triggering the random access procedure. For example, the order DCI triggering the random access procedure may include a bit indicating the coresetPoollndex value (e.g., the SRS resource set) associated with the random access message PUSCH (e.g., the Msg3 PUSCH or the MsgA PUSCH).

In another aspect, the first SRS resource set may be obtained based on at least one of a parameter associated with at least one of a SSB or a CSI-RS corresponding with the random access message, the parameter associated with PRACH occasion or preamble transmitted to the first TRP, or a PCI of a service cell on which the first PUSCH is scheduled.

In one example, the UE may be configured to determine the coresetPoollndex value (e.g., the SRS resource set) associated with the random access message PUSCH (e.g., the Msg3 PUSCH or the MsgA PUSCH) based on the coresetPoollndex value associated with the corresponding SSB/CSI-RS associated with the random access message PUSCH transmission. Here, the SSB/CSI-RS may be used for beam control or the power control for the random access message PUSCH (e.g., the Msg3 PUSCH or the MsgA PUSCH) transmission, and each SSB/CSI-RS may be configured or associated with one CORESET group of the two CORESET groups corresponding to the two coresetPoollndex values. For example, the association of the each SSB/CSI-RS and the CORESET groups may be configured by an RRC configuration. Accordingly, based on the associated between the coresetPoollndex values and the SSBs/CSI-RSs, the UE may determine the coresetPoollndex value (e.g., the SRS resource set) associated with the SSB/CSI-RS associated with the random access message PUSCH transmission.

In another example, the UE may be configured to determine the coresetPoollndex value (e.g., the SRS resource set) associated with the random access message PUSCH (e.g., the Msg3 PUSCH or the MsgA PUSCH) based on the coresetPoollndex value that is associated with a corresponding PRACH occasion or preamble transmitted to the first TRP before the corresponding random access message PUSCH (e.g., the Msg3 PUSCH or the MsgA PUSCH). That is, the UE may identify the coresetPoollndex value associated with the PRACH occasion or preamble transmitted to the first TRP, and determine the identified coresetPoollndex value associated with the PRACH occasion or preamble as the coresetPoollndex value (e.g., the SRS resource set) associated with the random access message PUSCH (e.g., the Msg3 PUSCH or the MsgA PUSCH).

In another example, the UE may be configured to determine the coresetPoollndex value (e.g., the SRS resource set) associated with the random access message PUSCH (e.g., the Msg3 PUSCH or the MsgA PUSCH) based on a physical cell identifier (ID) (PCI) associated with the serving cell corresponding to the transmission of the random access message. In case the two TRPs are associated with different cells and the UE is configured with an inter-cell mTRP transmission, each PCI of each serving cell may be associated with one coresetPoollndex value. Accordingly, the UE may refer to the service cell PCIs of the cells associated with the two TRPs to identify the coresetPoollndex value (e.g., the SRS resource set) associated with the random access message PUSCH (e.g., the Msg3 PUSCH or the MsgA PUSCH).

At 812, the UE may identify priorities of the first PUSCH and the second PUSCH. In one aspect, the one of the first PUSCH and the second PUSCH transmitted to the first TRP has a higher priority, and an other one of the first PUSCH or the second PUSCH refrained from transmitting to the first TRP has a lower priority. In one example, the random access message PUSCH (e.g., the Msg3 PUSCH or the MsgA PUSCH) may have a higher priority than the other PUSCH, and based on determining that the random access message PUSCH (e.g., the Msg3 PUSCH or the MsgA PUSCH) and the other PUSCH are associated with the same coresetPoollndex values (e.g., the same SRS resource set), the UE may transmit the random access message PUSCH (e.g., the Msg3 PUSCH or the MsgA PUSCH) and drop the other PUSCH at 714. In another example, the random access message PUSCH (e.g., the Msg3 PUSCH or the MsgA PUSCH) may have a lower priority than the other PUSCH, and based on determining that the random access message PUSCH (e.g., the Msg3 PUSCH or the MsgA PUSCH) and the other PUSCH are associated with the same coresetPoollndex values (e.g., the same SRS resource set), the UE may drop the random access message PUSCH (e.g., the Msg3 PUSCH or the MsgA PUSCH) and transmit the other PUSCH (e.g., based on some priority rule) at 714. For example, at 712, the UE 702 may identify priorities of the first PUSCH and the second PUSCH. Furthermore, 812 may be performed by the mTRP RACH configuration component 198.

At 814, the UE may transmit or refrain from transmitting, to a first TRP, the first PUSCH based on the first SRS resource set and a second SRS resource set associated with the second PUSCH. For example, at 714, the UE 702 may transmit or refrain from transmitting, to a first TRP 704, the first PUSCH based on the first SRS resource set and a second SRS resource set associated with the second PUSCH. Furthermore, 814 may be performed by the mTRP RACH configuration component 198.

In some aspects, the first PUSCH carrying the random access message may be transmitted based on the first SRS resource set and a second SRS resource set associated with the second PUSCH. That is, the UE may determine or obtain the associated coresetPoollndex value (e.g., associated SRS resource set) for a random access message PUSCH (e.g., the Msg3 PUSCH or the MsgA PUSCH) at 808, and determine whether another time-domain overlapping PUSCH may be transmitted simultaneously with the random access message PUSCH (e.g., the Msg3 PUSCH or the MsgA PUSCH).

In one example, the UE may transmit the first PUSCH and the second PUSCH overlapping at least in part in the time domain based on the first SRS resource set obtained at 808 being different from the second SRS resource set. That is, if the random access message PUSCH (e.g., the Msg3 PUSCH or the MsgA PUSCH) and the other PUSCH are associated with different coresetPoollndex values (e.g., different SRS resource sets), the UE may determine to transmit the random access message PUSCH (e.g., the Msg3 PUSCH or the MsgA PUSCH) and the other PUSCH.

If the random access message PUSCH (e.g., the Msg3 PUSCH or the MsgA PUSCH) and the other PUSCH are associated with the same coresetPoollndex values (e.g., the same SRS resource set), the UE may determine whether to refrain from transmitting both of the random access message PUSCH (e.g., the Msg3 PUSCH or the MsgA PUSCH) and the other PUSCH or transmit one of the random access message PUSCH (e.g., the Msg3 PUSCH or the MsgA PUSCH) and the other PUSCH.

In one example, the UE may dismiss the first PUSCH and the second PUSCH based on the first SRS resource set obtained at 808 being same as the second SRS resource set. Based on determining that the random access message PUSCH (e.g., the Msg3 PUSCH or the MsgA PUSCH) and the other PUSCH are associated with the same coresetPoollndex values (e.g., the same SRS resource set), the UE may determine that this is an error case that may not be a proper configuration or scheduling. Accordingly, the UE may determine to disregard both of the random access message PUSCH (e.g., the Msg3 PUSCH or the MsgA PUSCH) and the other PUSCH associated with the same coresetPoollndex values (e.g., the same SRS resource set), and refrain from transmitting the random access message PUSCH (e.g., the Msg3 PUSCH or the MsgA PUSCH) and the other PUSCH.

In another example, the UE may transmit, to the first TRP, one of the first PUSCH or the second PUSCH and refrain from transmitting an other one of the first PUSCH or the second PUSCH based on the first SRS resource set obtained at 808 being same as the second SRS resource set. Based on determining that the random access message PUSCH (e.g., the Msg3 PUSCH or the MsgA PUSCH) and the other PUSCH are associated with the same coresetPoollndex values (e.g., the same SRS resource set), the UE may drop one of the random access message PUSCH (e.g., the Msg3 PUSCH or the MsgA PUSCH) or the other PUSCH (e.g., based on some priority rule). For example, based on determining that the random access message PUSCH (e.g., the Msg3 PUSCH or the MsgA PUSCH) and the other PUSCH are associated with the same coresetPoollndex values (e.g., the same SRS resource set), the UE may be configured to transmit the random access message PUSCH (e.g., the Msg3 PUSCH or the MsgA PUSCH) and drop the other PUSCH. For example, based on determining that the random access message PUSCH (e.g., the Msg3 PUSCH or the MsgA PUSCH) and the other PUSCH are associated with the same coresetPoollndex values (e.g., the same SRS resource set), the UE may be configured to drop one the random access message PUSCH (e.g., the Msg3 PUSCH or the MsgA PUSCH) and transmit the other PUSCH (e.g., based on some priority rule).

In some aspects, the first PUSCH carrying the random access message may be transmitted based on the closed loop index obtained at 710. When a PUCCH is configured with two adjustment states (e.g., through the RRC configuration twoPUCCH-PC-AdjustmentStates), the determined closed loop index 1 of the PUSCH may be used to reset the closed loop adjustment state for the PUCCH corresponding to the same closed loop index 1. For example, the closed loop index value of 0 may represent the first closed loop index associated with the first TRP, and the closed loop index value of 1 may represent the second closed loop index associated with the second TRP.

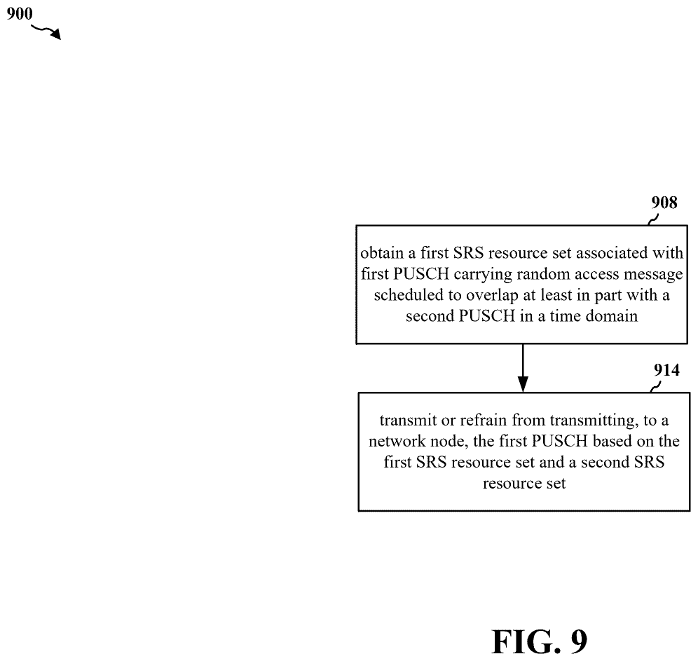

FIG. 9 is a flowchart 900 of a method of wireless communication. The method may be performed by a UE (e.g., the UE 104/602; the apparatus 1404). The UE may be configured with a multi-DCI based mTRP transmission with a first TRP and a second TRP. The UE may be configured to obtain a SRS resource set (e.g., the coresetPoollndex value) associated with a PUSCH carrying a random access message. The UE may manage the transmission of the PUSCH based on the obtained SRS resource set.

At 908, the UE may obtain a first SRS resource set associated with a first PUSCH carrying a random access message to be transmitted to a first TRP, the first PUSCH being scheduled to overlap at least in part with a second PUSCH in a time domain. The UE may obtain a coresetPoollndex value associated with the first PUSCH carrying the random access message to be transmitted to the first TRP. For example, at 708, the UE 702 may obtain a first SRS resource set associated with a first PUSCH carrying a random access message to be transmitted to a first TRP 704, the first PUSCH being scheduled to overlap at least in part with a second PUSCH in a time domain. Furthermore, 908 may be performed by the mTRP RACH configuration component 198.

In one aspect, the first PUSCH carrying the random access message may be scheduled in response to a random access response, and the first SRS resource set may be obtained based on at least one of a random access response PDSCH, a random access response PDCCH, or a parameter associated with the random access response PDCCH.

In one example, the UE may be configured to determine the coresetPoollndex value (e.g., the SRS resource set) associated with the random access message PUSCH (e.g., the Msg3 PUSCH) based on an indication in the RAR PDSCH. In case of the 4-step random access procedure, the coresetPoollndex value (e.g., the SRS resource set) associated with the random access message PUSCH (e.g., the Msg3 PUSCH) may be indicated in the Msg2 (e.g., the RAR PDSCH). For example, a reserved bit in the CSI request field of the RAR PDSCH may be used to indicate the coresetPoollndex value (e.g., the SRS resource set) associated with the random access message PUSCH (e.g., the Msg3 PUSCH).

In another example, the UE may be configured to determine the coresetPoollndex value (e.g., the SRS resource set) associated with the random access message PUSCH (e.g., the Msg3 PUSCH) based on an indication in a RAR PDCCH. The RAR PDCCH may refer to a DCI format 1_0 with the CRC scrambled with the RA-RNTI received from the first TRP within the RAR window. For example, a reserved bit in the DCI format 1_0 with CRC scrambled with RA-RNTI may be used to indicate the coresetPoollndex value (e.g., the SRS resource set) associated with the random access message PUSCH (e.g., the Msg3 PUSCH).

In another example, the UE may be configured to determine the coresetPoollndex value (e.g., the SRS resource set) associated with the random access message PUSCH (e.g., the Msg3 PUSCH) based on the coresetPoollndex value associated with the RAR PDCCH. That is, the RAR PDCCH received from the first TRP scheduling the RAR PDSCH (Msg2 payload) may have a CORESET in which the RAR PDCCH was received. The UE may refer to coresetPoollndex value associated with the CORESET in which the DCI format 1_0 with the CRC scrambled with the RA-RNTI was received from the first TRP, and use the coresetPoollndex value associated with the Msg2 PDSCH as the coresetPoollndex value (e.g., the SRS resource set) associated with the random access message PUSCH (e.g., the Msg3 PUSCH).

In another aspect, the first SRS resource set associated with the first PUSCH carrying the random access message may be a default value configured for the UE. The UE may be configured to determine the coresetPoollndex value (e.g., the SRS resource set) associated with the random access message PUSCH (e.g., the Msg3 PUSCH or the MsgA PUSCH) as a default value (e.g., a fixed coresetPoollndex value). For example, the coresetPoollndex value (e.g., the SRS resource set) associated with the random access message PUSCH (e.g., the Msg3 PUSCH or the MsgA PUSCH) may be set to a value of 0.

In another aspect, the UE may receive a PDCCH including an order to initiate a random access procedure at 906, and the first PUSCH carrying the random access message may be scheduled in response to the PDCCH including the order to initiate the random access procedure. The first SRS resource set may be obtained based on at least one of the PDCCH including the order to initiate the random access procedure, or a parameter associated with the PDCCH including the order to initiate the random access procedure.

In one example, the UE may be configured to determine the coresetPoollndex value (e.g., the SRS resource set) associated with the random access message PUSCH (e.g., the Msg3 PUSCH or the MsgA PUSCH) based on an indication in the PDCCH received from the first TRP that triggers the random-access procedure. That is, in case the random access procedure is triggered by an order DCI included in a PDCCH, the coresetPoollndex value (e.g., the SRS resource set) associated with the random access message PUSCH (e.g., the Msg3 PUSCH or the MsgA PUSCH) may be determined based on the PDCCH (order PDCCH) carrying the order DCI triggering the random access procedure. For example, the coresetPoollndex value associated with the CORESET that the order PDSCH was received from the first TRP may be determined as the coresetPoollndex value (e.g., the SRS resource set) associated with the random access message PUSCH (e.g., the Msg3 PUSCH or the MsgA PUSCH).

In another example, the UE may be configured to determine the coresetPoollndex value (e.g., the SRS resource set) associated with the random access message PUSCH (e.g., the Msg3 PUSCH or the MsgA PUSCH) based on the coresetPoollndex value associated with the PDCCH order DCI that triggers the random-access procedure. That is, in case the random access procedure is triggered by an order DCI included in a PDCCH, the coresetPoollndex value (e.g., the SRS resource set) associated with the random access message PUSCH (e.g., the Msg3 PUSCH or the MsgA PUSCH) may be determined based on the PDCCH (order PDCCH) carrying the order DCI triggering the random access procedure. For example, the order DCI triggering the random access procedure may include a bit indicating the coresetPoollndex value (e.g., the SRS resource set) associated with the random access message PUSCH (e.g., the Msg3 PUSCH or the MsgA PUSCH).

In another aspect, the first SRS resource set may be obtained based on at least one of a parameter associated with at least one of a SSB or a CSI-RS corresponding with the random access message, the parameter associated with PRACH occasion or preamble transmitted to the first TRP, or a PCI of a service cell on which the first PUSCH is scheduled.

In one example, the UE may be configured to determine the coresetPoollndex value (e.g., the SRS resource set) associated with the random access message PUSCH (e.g., the Msg3 PUSCH or the MsgA PUSCH) based on the coresetPoollndex value associated with the corresponding SSB/CSI-RS associated with the random access message PUSCH transmission. Here, the SSB/CSI-RS may be used for beam control or the power control for the random access message PUSCH (e.g., the Msg3 PUSCH or the MsgA PUSCH) transmission, and each SSB/CSI-RS may be configured or associated with one CORESET group of the two CORESET groups corresponding to the two coresetPoollndex values. For example, the association of the each SSB/CSI-RS and the CORESET groups may be configured by an RRC configuration. Accordingly, based on the associated between the coresetPoollndex values and the SSBs/CSI-RSs, the UE may determine the coresetPoollndex value (e.g., the SRS resource set) associated with the SSB/CSI-RS associated with the random access message PUSCH transmission.

In another example, the UE may be configured to determine the coresetPoollndex value (e.g., the SRS resource set) associated with the random access message PUSCH (e.g., the Msg3 PUSCH or the MsgA PUSCH) based on the coresetPoollndex value that is associated with a corresponding PRACH occasion or preamble transmitted to the first TRP before the corresponding random access message PUSCH (e.g., the Msg3 PUSCH or the MsgA PUSCH). That is, the UE may identify the coresetPoollndex value associated with the PRACH occasion or preamble transmitted to the first TRP, and determine the identified coresetPoollndex value associated with the PRACH occasion or preamble as the coresetPoollndex value (e.g., the SRS resource set) associated with the random access message PUSCH (e.g., the Msg3 PUSCH or the MsgA PUSCH).

In another example, the UE may be configured to determine the coresetPoollndex value (e.g., the SRS resource set) associated with the random access message PUSCH (e.g., the Msg3 PUSCH or the MsgA PUSCH) based on a physical cell identifier (ID) (PCI) associated with the serving cell corresponding to the transmission of the random access message. In case the two TRPs are associated with different cells and the UE is configured with an inter-cell mTRP transmission, each PCI of each serving cell may be associated with one coresetPoollndex value. Accordingly, the UE may refer to the service cell PCIs of the cells associated with the two TRPs to identify the coresetPoollndex value (e.g., the SRS resource set) associated with the random access message PUSCH (e.g., the Msg3 PUSCH or the MsgA PUSCH).

At 914, the UE may transmit or refrain from transmitting, to a first TRP, the first PUSCH based on the first SRS resource set and a second SRS resource set associated with the second PUSCH. For example, at 714, the UE 702 may transmit or refrain from transmitting, to a first TRP 704, the first PUSCH based on the first SRS resource set and a second SRS resource set associated with the second PUSCH. Furthermore, 914 may be performed by the mTRP RACH configuration component 198.

In some aspects, the first PUSCH carrying the random access message may be transmitted based on the first SRS resource set and a second SRS resource set associated with the second PUSCH. That is, the UE may determine or obtain the associated coresetPoollndex value (e.g., associated SRS resource set) for a random access message PUSCH (e.g., the Msg3 PUSCH or the MsgA PUSCH) at 908, and determine whether another time-domain overlapping PUSCH may be transmitted simultaneously with the random access message PUSCH (e.g., the Msg3 PUSCH or the MsgA PUSCH).

In one example, the UE may transmit the first PUSCH and the second PUSCH overlapping at least in part in the time domain based on the first SRS resource set obtained at 908 being different from the second SRS resource set. That is, if the random access message PUSCH (e.g., the Msg3 PUSCH or the MsgA PUSCH) and the other PUSCH are associated with different coresetPoollndex values (e.g., different SRS resource sets), the UE may determine to transmit the random access message PUSCH (e.g., the Msg3 PUSCH or the MsgA PUSCH) and the other PUSCH.

If the random access message PUSCH (e.g., the Msg3 PUSCH or the MsgA PUSCH) and the other PUSCH are associated with the same coresetPoollndex values (e.g., the same SRS resource set), the UE may determine whether to refrain from transmitting both of the random access message PUSCH (e.g., the Msg3 PUSCH or the MsgA PUSCH) and the other PUSCH or transmit one of the random access message PUSCH (e.g., the Msg3 PUSCH or the MsgA PUSCH) and the other PUSCH.

In one example, the UE may dismiss the first PUSCH and the second PUSCH based on the first SRS resource set obtained at 908 being same as the second SRS resource set. Based on determining that the random access message PUSCH (e.g., the Msg3 PUSCH or the MsgA PUSCH) and the other PUSCH are associated with the same coresetPoollndex values (e.g., the same SRS resource set), the UE may determine that this is an error case that may not be a proper configuration or scheduling. Accordingly, the UE may determine to disregard both of the random access message PUSCH (e.g., the Msg3 PUSCH or the MsgA PUSCH) and the other PUSCH associated with the same coresetPoollndex values (e.g., the same SRS resource set), and refrain from transmitting the random access message PUSCH (e.g., the Msg3 PUSCH or the MsgA PUSCH) and the other PUSCH.

In another example, the UE may transmit, to the first TRP, one of the first PUSCH or the second PUSCH and refrain from transmitting an other one of the first PUSCH or the second PUSCH based on the first SRS resource set obtained at 908 being same as the second SRS resource set. Based on determining that the random access message PUSCH (e.g., the Msg3 PUSCH or the MsgA PUSCH) and the other PUSCH are associated with the same coresetPoollndex values (e.g., the same SRS resource set), the UE may drop one of the random access message PUSCH (e.g., the Msg3 PUSCH or the MsgA PUSCH) or the other PUSCH (e.g., based on some priority rule). For example, based on determining that the random access message PUSCH (e.g., the Msg3 PUSCH or the MsgA PUSCH) and the other PUSCH are associated with the same coresetPoollndex values (e.g., the same SRS resource set), the UE may be configured to transmit the random access message PUSCH (e.g., the Msg3 PUSCH or the MsgA PUSCH) and drop the other PUSCH. For example, based on determining that the random access message PUSCH (e.g., the Msg3 PUSCH or the MsgA PUSCH) and the other PUSCH are associated with the same coresetPoollndex values (e.g., the same SRS resource set), the UE may be configured to drop one the random access message PUSCH (e.g., the Msg3 PUSCH or the MsgA PUSCH) and transmit the other PUSCH (e.g., based on some priority rule).

In some aspects, the first PUSCH carrying the random access message may be transmitted based on the closed loop index obtained at 710. When a PUCCH is configured with two adjustment states (e.g., through the RRC configuration twoPUCCH-PC-AdjustmentStates), the determined closed loop index 1 of the PUSCH may be used to reset the closed loop adjustment state for the PUCCH corresponding to the same closed loop index 1. For example, the closed loop index value of 0 may represent the first closed loop index associated with the first TRP, and the closed loop index value of 1 may represent the second closed loop index associated with the second TRP.

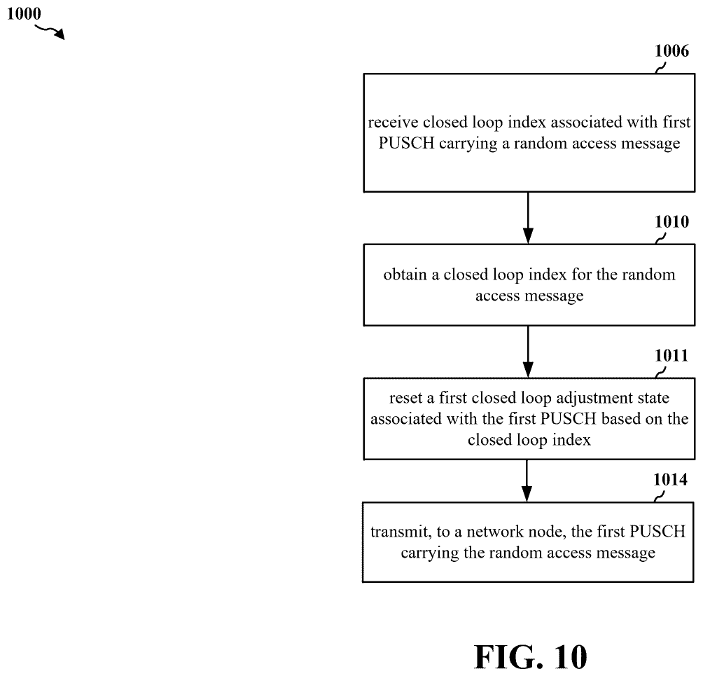

FIG. 10 is a flowchart 1000 of a method of wireless communication. The method may be performed by a UE (e.g., the UE 104/602; the apparatus 1404). The UE may be configured with a multi-DCI based mTRP transmission with a first TRP and a second TRP. The UE may be configured to obtain a closed loop index associated with a PUSCH carrying random access message. The UE may manage the transmission of the PUSCH based on the obtained SRS resource set.

At 1006, the UE may receive, from the network node, an indication of a closed loop index associated with a first PUSCH carrying a random access message to be transmitted to the first TRP, the first PUSCH being scheduled to overlap at least in part with a second PUSCH in a time domain. In one example, the indication of the closed loop index associated with the first PUSCH carrying the random access message may include at least one of a random access response PDSCH, a random access response PDCCH, or a parameter associated with the random access response PDCCH. In another example, the indication of the closed loop index associated with the first PUSCH carrying the random access message may be transmitted via a PDCCH including an order to initiate a random access procedure, and the indication may include at least one of the PDCCH including the order to initiate the random access procedure, or a parameter associated with the PDCCH including the order to initiate the random access procedure. In another example, the indication of the closed loop index associated with the first PUSCH carrying the random access message may include at least one of a parameter associated with at least one of a SSB or a CSI-RS corresponding with the random access message, the parameter associated with PRACH occasion or preamble transmitted to the first TRP, or a PCI of a service cell on which the first PUSCH is scheduled. For example, at 706, the UE 702 may receive, from the first TRP 704, an indication of at least one of a first SRS resource set or a closed loop index associated with a first PUSCH carrying a random access message to be transmitted to the first TRP 704, the first PUSCH being scheduled to overlap at least in part with a second PUSCH in a time domain. Furthermore, 1006 may be performed by an mTRP RACH configuration component 198.

At 1010, the UE may obtain a closed loop index for the random access message. That is, the UE configured with multi-DCI based mTRP transmission may determine to reset a closed loop adjustment state for transmitting the random access message PUSCH (e.g., the Msg3 PUSCH or the MsgA PUSCH) to a first closed loop adjustment state or a second closed loop adjustment state. The closed loop index may indicate that a first closed loop adjustment state from the first closed loop adjustment state and a second closed loop adjustment state is to be reset. Here, the two closed loops for PUSCH may be configured by the first TRP. (e.g., by a RRC configuration, twoPUSCH-PC-AdjustmentStates) Also, when a PUCCH is configured with two adjustment states (e.g., through the RRC configuration twoPUCCH-PC-AdjustmentStates), the determined closed loop index 1 of the PUSCH may be used to reset the closed loop adjustment state for the PUCCH corresponding to the same closed loop index 1. For example, the closed loop index value of 0 may represent the first closed loop index associated with the first TRP, and the closed loop index value of 1 may represent the second closed loop index associated with the second TRP. The UE may determine the closed loop index (e.g., 1=0 or 1) using various ways. For example, at 710, the UE 702 may obtain a closed loop index for the random access message. That is, the UE 702 configured with multi-DCI based mTRP transmission may determine to reset a closed loop adjustment state for transmitting the random access message PUSCH (e.g., the Msg3 PUSCH or the MsgA PUSCH) to a first closed loop adjustment state or a second closed loop adjustment state. Furthermore, 1010 may be performed by the mTRP RACH configuration component 198.

In one aspect, closed loop index for the first PUSCH carrying the random access message may be associated with the SRS resource set associated with the random access message as obtained at 1008. That is, the UE may first obtain the coresetPoollndex value associated with the Msg3 PUSCH or the MsgA PUSCH based on various ways at 1008, and then determine the closed loop index associated with based on the obtained coresetPoollndex value associated the Msg3 PUSCH or the MsgA PUSCH.

In another aspect, the first PUSCH carrying the random access message may be scheduled in response to a random access response received at 1006, and the closed loop index may be obtained based on at least one of a random access response PDSCH, a random access response PDCCH, or a parameter associated with the random access response PDCCH.

In one example, the UE may be configured to determine the closed loop index associated with the random access message PUSCH (e.g., the Msg3 PUSCH) based on an indication in the RAR PDSCH. For example, in case of the 4-step random access procedure, a reserved bit in the CSI request field of the RAR PDSCH may be used to indicate the closed loop index associated with the random access message PUSCH (e.g., the Msg3 PUSCH).

In another example, the UE may be configured to determine the closed loop index associated with the random access message PUSCH (e.g., the Msg3 PUSCH) based on an indication in a RAR PDCCH. For example, in case of the 4-step random access procedure, a reserved bit in the DCI format 1_0 with CRC scrambled with RA-RNTI may be used to indicate the closed loop index associated with the random access message PUSCH (e.g., the Msg3 PUSCH).

In another example, the UE may be configured to determine the closed loop index associated with the random access message PUSCH (e.g., the Msg3 PUSCH) based on the coresetPoollndex value associated with the RAR PDCCH. The UE may use the coresetPoollndex value associated with the CORESET in which the DCI format 1_0 with the CRC scrambled with the RA-RNTI received from the first TRP as the closed loop index associated with the random access message PUSCH (e.g., the Msg3 PUSCH).

In another aspect, the closed loop index associated with the first PUSCH carrying the random access message may be a default value configured for the UE. That is, the UE may be configured to determine the closed loop index associated with the random access message PUSCH (e.g., the Msg3 PUSCH or the MsgA PUSCH) as a default value (e.g., a fixed closed loop index value). For example, the closed loop index associated with the random access message PUSCH (e.g., the Msg3 PUSCH or the MsgA PUSCH) may be set to a value of 0.

In another aspect, the UE may receive a PDCCH including an order to initiate a random access procedure at 1006, and the first PUSCH carrying the random access message may be scheduled in response to the PDCCH including the order to initiate the random access procedure. The closed loop index may be obtained based on at least one of the PDCCH including the order to initiate the random access procedure, or a parameter associated with the PDCCH including the order to initiate the random access procedure.

In one example, the UE may be configured to determine the closed loop index associated with the random access message PUSCH (e.g., the Msg3 PUSCH or the MsgA PUSCH) based on an indication in the PDCCH received from the first TRP that triggers the random-access procedure. For example, the coresetPoollndex value associated with the CORESET that the order PDSCH was received from the first TRP may be determined as the closed loop index associated with the random access message PUSCH (e.g., the Msg3 PUSCH or the MsgA PUSCH).

In another example, the UE may be configured to determine the closed loop index associated with the random access message PUSCH (e.g., the Msg3 PUSCH or the MsgA PUSCH) based on the coresetPoollndex value associated with the PDCCH order DCI that triggers the random-access procedure. For example, the order DCI triggering the random access procedure may include a bit indicating the closed loop index associated with the random access message PUSCH (e.g., the Msg3 PUSCH or the MsgA PUSCH).

In another aspect, the closed loop index may be obtained based on at least one of a parameter associated with at least one of a SSB or a CSI-RS corresponding with the random access message, the parameter associated with PRACH occasion or preamble transmitted to the first TRP, or a PCI of a service cell on which the first PUSCH is scheduled.

In one example, the UE may be configured to determine the closed loop index associated with the random access message PUSCH (e.g., the Msg3 PUSCH or the MsgA PUSCH) based on the coresetPoollndex value associated with the corresponding SSB/CSI-RS associated with the random access message PUSCH transmission. For example, the association of the each SSB/CSI-RS and the CORESET groups may be configured by an RRC configuration, and based on the associated between the coresetPoollndex values and the SSBs/CSI-RSs, the UE may determine the closed loop index associated with the SSB/CSI-RS associated with the random access message PUSCH transmission.

In another example, the UE may be configured to determine the closed loop index associated with the random access message PUSCH (e.g., the Msg3 PUSCH or the MsgA PUSCH) based on the coresetPoollndex value that is associated with a corresponding PRACH occasion or preamble transmitted to the first TRP before the corresponding random access message PUSCH (e.g., the Msg3 PUSCH or the MsgA PUSCH).

In another example, the UE may be configured to determine the closed loop index associated with the random access message PUSCH (e.g., the Msg3 PUSCH or the MsgA PUSCH) based on a physical cell identifier (ID) (PCI) associated with the serving cell corresponding to the transmission of the random access message. In case the two TRPs are associated with different cells and the UE is configured with an inter-cell mTRP transmission, each PCI of each serving cell may be associated with one coresetPoollndex value, and the UE may refer to the service cell PCIs of the cells associated with the two TRPs to identify the closed loop index associated with the random access message PUSCH (e.g., the Msg3 PUSCH or the MsgA PUSCH).

At 1011, the UE may reset a first closed loop adjustment state associated with the first PUSCH carrying the random access message based on the closed loop index. That is, the UE may reset the first closed loop adjustment state associated with the first PUSCH carrying the random access message when resetting the first closed loop adjustment state associated with the first PUSCH carrying the random access message corresponds with the first TRP and reduce or avoid unnecessary reset of adjustment state and improve the efficiency of the multi-DCI based mTRP transmissions. For example, at 711, the UE 702 may reset a first closed loop adjustment state associated with the first PUSCH carrying the random access message based on the closed loop index. Furthermore, 1011 may be performed by the mTRP RACH configuration component 198.

At 1014, the UE may transmit, to the network node, the first PUSCH carrying the random access message based on the closed loop index. In some aspects, the first PUSCH carrying the random access message may be transmitted based on the closed loop index obtained at 710. That is, when a PUCCH is configured with two adjustment states (e.g., through the RRC configuration twoPUCCH-PC-AdjustmentStates), the determined closed loop index 1 of the PUSCH may be used to reset the closed loop adjustment state for the PUCCH corresponding to the same closed loop index 1. The UE 702 may reset the first closed loop adjustment state associated with the first PUSCH carrying the random access message when resetting the first closed loop adjustment state associated with the first PUSCH carrying the random access message corresponds with the first TRP and reduce or avoid unnecessary reset of adjustment state and improve the efficiency of the multi-DCI based mTRP transmissions. For example, the closed loop index value of 0 may represent the first closed loop index associated with the first TRP, and the closed loop index value of 1 may represent the second closed loop index associated with the second TRP. For example, at 714, the UE 702 may transmit, to the first TRP 704, the first PUSCH carrying the random access message based on the closed loop index. Furthermore, 1014 may be performed by the mTRP RACH configuration component 198.

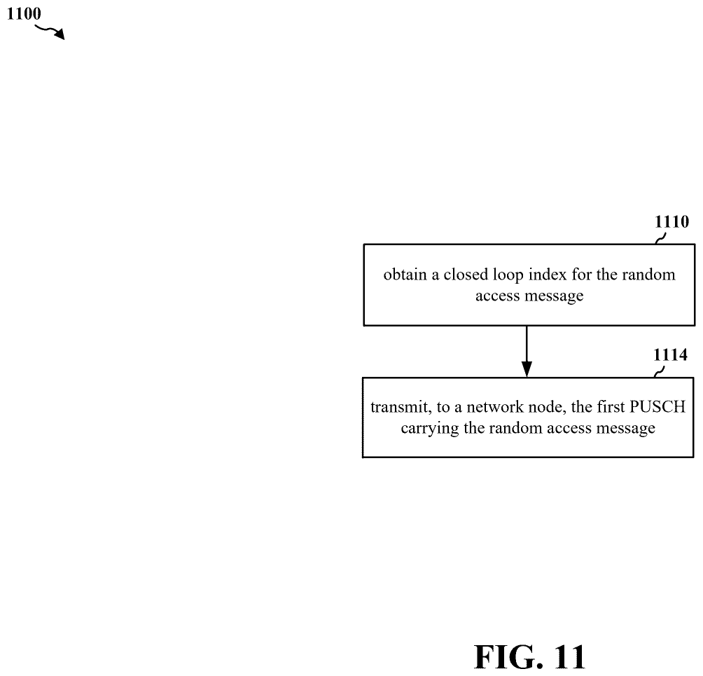

FIG. 11 is a flowchart 1100 of a method of wireless communication. The method may be performed by a UE (e.g., the UE 104/602; the apparatus 1404). The UE may be configured with a multi-DCI based mTRP transmission with a first TRP and a second TRP. The UE may be configured to obtain a closed loop index associated with a PUSCH carrying random access message. The UE may manage the transmission of the PUSCH based on the obtained SRS resource set.

At 1110, the UE may obtain a closed loop index for the random access message. That is, the UE configured with multi-DCI based mTRP transmission may determine to reset a closed loop adjustment state for transmitting the random access message PUSCH (e.g., the Msg3 PUSCH or the MsgA PUSCH) to a first closed loop adjustment state or a second closed loop adjustment state. The closed loop index may indicate that a first closed loop adjustment state from the first closed loop adjustment state and a second closed loop adjustment state is to be reset. Here, the two closed loops for PUSCH may be configured by the first TRP. (e.g., by a RRC configuration, twoPUSCH-PC-AdjustmentStates) Also, when a PUCCH is configured with two adjustment states (e.g., through the RRC configuration twoPUCCH-PC-AdjustmentStates), the determined closed loop index 1 of the PUSCH may be used to reset the closed loop adjustment state for the PUCCH corresponding to the same closed loop index 1. For example, the closed loop index value of 0 may represent the first closed loop index associated with the first TRP, and the closed loop index value of 1 may represent the second closed loop index associated with the second TRP. The UE may determine the closed loop index (e.g., 1=0 or 1) using various ways. For example, at 710, the UE 702 may obtain a closed loop index for the random access message. That is, the UE 702 configured with multi-DCI based mTRP transmission may determine to reset a closed loop adjustment state for transmitting the random access message PUSCH (e.g., the Msg3 PUSCH or the MsgA PUSCH) to a first closed loop adjustment state or a second closed loop adjustment state. Furthermore, 1110 may be performed by the mTRP RACH configuration component 198.

In one aspect, closed loop index for the first PUSCH carrying the random access message may be associated with the SRS resource set associated with the random access message as obtained at 1108. That is, the UE may first obtain the coresetPoollndex value associated with the Msg3 PUSCH or the MsgA PUSCH based on various ways at 1108, and then determine the closed loop index associated with based on the obtained coresetPoollndex value associated the Msg3 PUSCH or the MsgA PUSCH.

In another aspect, the first PUSCH carrying the random access message may be scheduled in response to a random access response received at 1106, and the closed loop index may be obtained based on at least one of a random access response PDSCH, a random access response PDCCH, or a parameter associated with the random access response PDCCH.

In one example, the UE may be configured to determine the closed loop index associated with the random access message PUSCH (e.g., the Msg3 PUSCH) based on an indication in the RAR PDSCH. For example, in case of the 4-step random access procedure, a reserved bit in the CSI request field of the RAR PDSCH may be used to indicate the closed loop index associated with the random access message PUSCH (e.g., the Msg3 PUSCH).

In another example, the UE may be configured to determine the closed loop index associated with the random access message PUSCH (e.g., the Msg3 PUSCH) based on an indication in a RAR PDCCH. For example, in case of the 4-step random access procedure, a reserved bit in the DCI format 1_0 with CRC scrambled with RA-RNTI may be used to indicate the closed loop index associated with the random access message PUSCH (e.g., the Msg3 PUSCH).

In another example, the UE may be configured to determine the closed loop index associated with the random access message PUSCH (e.g., the Msg3 PUSCH) based on the coresetPoollndex value associated with the RAR PDCCH. The UE may use the coresetPoollndex value associated with the CORESET in which the DCI format 1_0 with the CRC scrambled with the RA-RNTI received from the first TRP as the closed loop index associated with the random access message PUSCH (e.g., the Msg3 PUSCH).

In another aspect, the closed loop index associated with the first PUSCH carrying the random access message may be a default value configured for the UE. That is, the UE may be configured to determine the closed loop index associated with the random access message PUSCH (e.g., the Msg3 PUSCH or the MsgA PUSCH) as a default value (e.g., a fixed closed loop index value). For example, the closed loop index associated with the random access message PUSCH (e.g., the Msg3 PUSCH or the MsgA PUSCH) may be set to a value of 0.

In another aspect, the UE may receive a PDCCH including an order to initiate a random access procedure at 1106, and the first PUSCH carrying the random access message may be scheduled in response to the PDCCH including the order to initiate the random access procedure. The closed loop index may be obtained based on at least one of the PDCCH including the order to initiate the random access procedure, or a parameter associated with the PDCCH including the order to initiate the random access procedure.

In one example, the UE may be configured to determine the closed loop index associated with the random access message PUSCH (e.g., the Msg3 PUSCH or the MsgA PUSCH) based on an indication in the PDCCH received from the first TRP that triggers the random-access procedure. For example, the coresetPoollndex value associated with the CORESET that the order PDSCH was received from the first TRP may be determined as the closed loop index associated with the random access message PUSCH (e.g., the Msg3 PUSCH or the MsgA PUSCH).

In another example, the UE may be configured to determine the closed loop index associated with the random access message PUSCH (e.g., the Msg3 PUSCH or the MsgA PUSCH) based on the coresetPoollndex value associated with the PDCCH order DCI that triggers the random-access procedure. For example, the order DCI triggering the random access procedure may include a bit indicating the closed loop index associated with the random access message PUSCH (e.g., the Msg3 PUSCH or the MsgA PUSCH).

In another aspect, the closed loop index may be obtained based on at least one of a parameter associated with at least one of a SSB or a CSI-RS corresponding with the random access message, the parameter associated with PRACH occasion or preamble transmitted to the first TRP, or a PCI of a service cell on which the first PUSCH is scheduled.

In one example, the UE may be configured to determine the closed loop index associated with the random access message PUSCH (e.g., the Msg3 PUSCH or the MsgA PUSCH) based on the coresetPoollndex value associated with the corresponding SSB/CSI-RS associated with the random access message PUSCH transmission. For example, the association of the each SSB/CSI-RS and the CORESET groups may be configured by an RRC configuration, and based on the associated between the coresetPoollndex values and the SSBs/CSI-RSs, the UE may determine the closed loop index associated with the SSB/CSI-RS associated with the random access message PUSCH transmission.

In another example, the UE may be configured to determine the closed loop index associated with the random access message PUSCH (e.g., the Msg3 PUSCH or the MsgA PUSCH) based on the coresetPoollndex value that is associated with a corresponding PRACH occasion or preamble transmitted to the first TRP before the corresponding random access message PUSCH (e.g., the Msg3 PUSCH or the MsgA PUSCH).

In another example, the UE may be configured to determine the closed loop index associated with the random access message PUSCH (e.g., the Msg3 PUSCH or the MsgA PUSCH) based on a physical cell identifier (ID) (PCI) associated with the serving cell corresponding to the transmission of the random access message. In case the two TRPs are associated with different cells and the UE is configured with an inter-cell mTRP transmission, each PCI of each serving cell may be associated with one coresetPoollndex value, and the UE may refer to the service cell PCIs of the cells associated with the two TRPs to identify the closed loop index associated with the random access message PUSCH (e.g., the Msg3 PUSCH or the MsgA PUSCH).

At 1114, the UE may transmit, to the network node, the first PUSCH carrying the random access message based on the closed loop index. In some aspects, the first PUSCH carrying the random access message may be transmitted based on the closed loop index obtained at 710. That is, when a PUCCH is configured with two adjustment states (e.g., through the RRC configuration twoPUCCH-PC-AdjustmentStates), the determined closed loop index 1 of the PUSCH may be used to reset the closed loop adjustment state for the PUCCH corresponding to the same closed loop index 1. The UE 702 may reset the first closed loop adjustment state associated with the first PUSCH carrying the random access message when resetting the first closed loop adjustment state associated with the first PUSCH carrying the random access message corresponds with the first TRP and reduce or avoid unnecessary reset of adjustment state and improve the efficiency of the multi-DCI based mTRP transmissions. For example, the closed loop index value of 0 may represent the first closed loop index associated with the first TRP, and the closed loop index value of 1 may represent the second closed loop index associated with the second TRP. For example, at 714, the UE 702 may transmit, to the first TRP 704, the first PUSCH carrying the random access message based on the closed loop index. Furthermore, 1114 may be performed by the mTRP RACH configuration component 198.

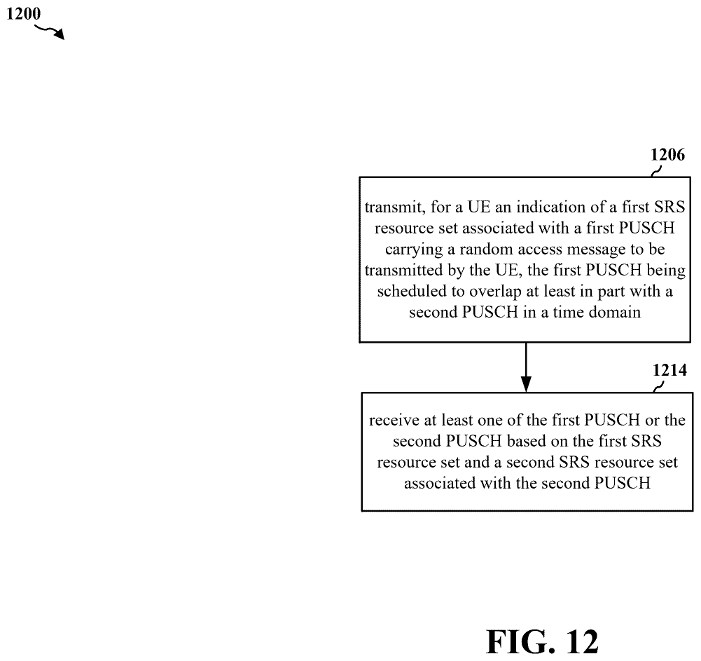

FIG. 12 is a flowchart 1200 of a method of wireless communication. The method may be performed by a network node (e.g., the base station 102; the first TRP 704; the network entity 1502/1660). The network node may be a first TRP, and a UE and the first TRP and a second TRP may be configured with a multi-DCI based mTRP transmission. The network node may indicate a SRS resource set (e.g., the coresetPoollndex value) associated with a PUSCH carrying a random access message to the UE. The network node may receive the PUSCH based on the SRS resource set indicated to the UE.

At 1206, the network node may transmit, for the UE, an indication of a first SRS resource set associated with a first PUSCH carrying a random access message to be transmitted by the UE, the first PUSCH being scheduled to overlap at least in part with a second PUSCH in a time domain. In one example, the indication of the first SRS resource set associated with the first PUSCH carrying the random access message may include at least one of a random access response PDSCH, a random access response PDCCH, or a parameter associated with the random access response PDCCH. In another example, the indication of the first SRS resource set associated with the first PUSCH carrying the random access message may be transmitted via a PDCCH including an order to initiate a random access procedure, and the indication may include at least one of the PDCCH including the order to initiate the random access procedure, or a parameter associated with the PDCCH including the order to initiate the random access procedure. In another example, the indication of the first SRS resource set associated with the first PUSCH carrying the random access message may include at least one of a parameter associated with at least one of a SSB or a CSI-RS corresponding with the random access message, the parameter associated with PRACH occasion or preamble transmitted to the first TRP, or a PCI of a service cell on which the first PUSCH is scheduled. For example, at 706, the first TRP 704 may transmit, for the UE 702, an indication of a first SRS resource set associated with a first PUSCH carrying a random access message to be transmitted by the UE 702, the first PUSCH being scheduled to overlap at least in part with a second PUSCH in a time domain. Furthermore, 1206 may be performed by an mTRP RACH configuring component 199.

At 1214, the network node may receive at least one of the first PUSCH or the second PUSCH based on the first SRS resource set and a second SRS resource set associated with the second PUSCH. For example, at 714, the first TRP 704 may receive at least one of the first PUSCH or the second PUSCH based on the first SRS resource set and a second SRS resource set associated with the second PUSCH. Furthermore, 1214 may be performed by the mTRP RACH configuring component 199.

In some aspects, the first PUSCH carrying the random access message may be transmitted based on the first SRS resource set and a second SRS resource set associated with the second PUSCH. That is, the UE may determine or obtain the associated coresetPoollndex value (e.g., associated SRS resource set) for a random access message PUSCH (e.g., the Msg3 PUSCH or the MsgA PUSCH) at 808, and determine whether another time-domain overlapping PUSCH may be transmitted simultaneously with the random access message PUSCH (e.g., the Msg3 PUSCH or the MsgA PUSCH).

In one example, the UE may transmit the first PUSCH and the second PUSCH overlapping at least in part in the time domain based on the first SRS resource set obtained at 808 being different from the second SRS resource set. That is, if the random access message PUSCH (e.g., the Msg3 PUSCH or the MsgA PUSCH) and the other PUSCH are associated with different coresetPoollndex values (e.g., different SRS resource sets), the UE may determine to transmit the random access message PUSCH (e.g., the Msg3 PUSCH or the MsgA PUSCH) and the other PUSCH.

If the random access message PUSCH (e.g., the Msg3 PUSCH or the MsgA PUSCH) and the other PUSCH are associated with the same coresetPoollndex values (e.g., the same SRS resource set), the UE may determine whether to refrain from transmitting both of the random access message PUSCH (e.g., the Msg3 PUSCH or the MsgA PUSCH) and the other PUSCH or transmit one of the random access message PUSCH (e.g., the Msg3 PUSCH or the MsgA PUSCH) and the other PUSCH.

In one example, the UE may dismiss the first PUSCH and the second PUSCH based on the first SRS resource set obtained at 808 being same as the second SRS resource set. Based on determining that the random access message PUSCH (e.g., the Msg3 PUSCH or the MsgA PUSCH) and the other PUSCH are associated with the same coresetPoollndex values (e.g., the same SRS resource set), the UE may determine that this is an error case that may not be a proper configuration or scheduling. Accordingly, the UE may determine to disregard both of the random access message PUSCH (e.g., the Msg3 PUSCH or the MsgA PUSCH) and the other PUSCH associated with the same coresetPoollndex values (e.g., the same SRS resource set), and refrain from transmitting the random access message PUSCH (e.g., the Msg3 PUSCH or the MsgA PUSCH) and the other PUSCH.

In another example, the UE may transmit, to the first TRP, one of the first PUSCH or the second PUSCH and refrain from transmitting an other one of the first PUSCH or the second PUSCH based on the first SRS resource set obtained at 808 being same as the second SRS resource set. Based on determining that the random access message PUSCH (e.g., the Msg3 PUSCH or the MsgA PUSCH) and the other PUSCH are associated with the same coresetPoollndex values (e.g., the same SRS resource set), the UE may drop one of the random access message PUSCH (e.g., the Msg3 PUSCH or the MsgA PUSCH) or the other PUSCH (e.g., based on some priority rule). For example, based on determining that the random access message PUSCH (e.g., the Msg3 PUSCH or the MsgA PUSCH) and the other PUSCH are associated with the same coresetPoollndex values (e.g., the same SRS resource set), the UE may be configured to transmit the random access message PUSCH (e.g., the Msg3 PUSCH or the MsgA PUSCH) and drop the other PUSCH. For example, based on determining that the random access message PUSCH (e.g., the Msg3 PUSCH or the MsgA PUSCH) and the other PUSCH are associated with the same coresetPoollndex values (e.g., the same SRS resource set), the UE may be configured to drop one the random access message PUSCH (e.g., the Msg3 PUSCH or the MsgA PUSCH) and transmit the other PUSCH (e.g., based on some priority rule).

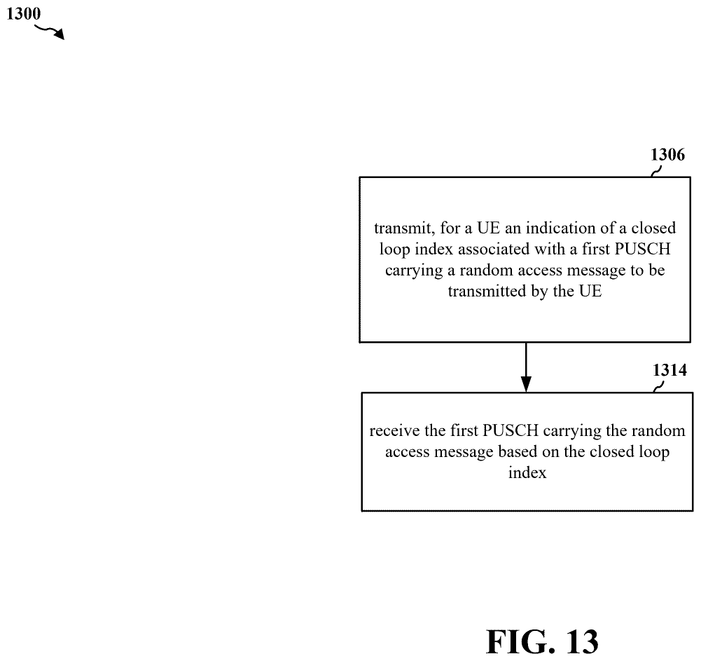

FIG. 13 is a flowchart 1300 of a method of wireless communication. The method may be performed by a network node (e.g., the base station 102; the first TRP 704; the network entity 1502/1660). The network node may be a first TRP, and a UE and the first TRP and a second TRP may be configured with a multi-DCI based mTRP transmission. The network node may indicate a SRS resource set (e.g., the coresetPoollndex value) associated with a PUSCH carrying a random access message to the UE. The network node may receive the PUSCH based on the SRS resource set indicated to the UE.

At 1306 the network node may transmit, for a UE, an indication of a closed loop index associated with a first PUSCH carrying a random access message to be transmitted by the UE. In one example, the indication of the closed loop index associated with the first PUSCH carrying the random access message may include at least one of a random access response PDSCH, a random access response PDCCH, or a parameter associated with the random access response PDCCH. In another example, the indication of the closed loop index associated with the first PUSCH carrying the random access message may be transmitted via a PDCCH including an order to initiate a random access procedure, and the indication may include at least one of the PDCCH including the order to initiate the random access procedure, or a parameter associated with the PDCCH including the order to initiate the random access procedure. In another example, the indication of the closed loop index associated with the first PUSCH carrying the random access message may include at least one of a parameter associated with at least one of a SSB or a CSI-RS corresponding with the random access message, the parameter associated with PRACH occasion or preamble transmitted to the first TRP, or a PCI of a service cell on which the first PUSCH is scheduled. For example, at 706, the first TRP 704 may transmit, for a UE 702, an indication of a closed loop index associated with a first PUSCH carrying a random access message to be transmitted by the UE 702. Furthermore, 1306 may be performed by an mTRP RACH configuring component 199.

At 1314 the network node may receive the first PUSCH carrying the random access message based on the closed loop index. That is, when a PUCCH is configured with two adjustment states (e.g., through the RRC configuration twoPUCCH-PC-AdjustmentStates), the determined closed loop index 1 of the PUSCH may be used to reset the closed loop adjustment state for the PUCCH corresponding to the same closed loop index 1. The UE 702 may reset the first closed loop adjustment state associated with the first PUSCH carrying the random access message when resetting the first closed loop adjustment state associated with the first PUSCH carrying the random access message corresponds with the first TRP and reduce or avoid unnecessary reset of adjustment state and improve the efficiency of the multi-DCI based mTRP transmissions. For example, at 714, the first TRP 704 may receive the first PUSCH carrying the random access message based on the closed loop index. Furthermore, 1314 may be performed by the mTRP RACH configuring component 199.

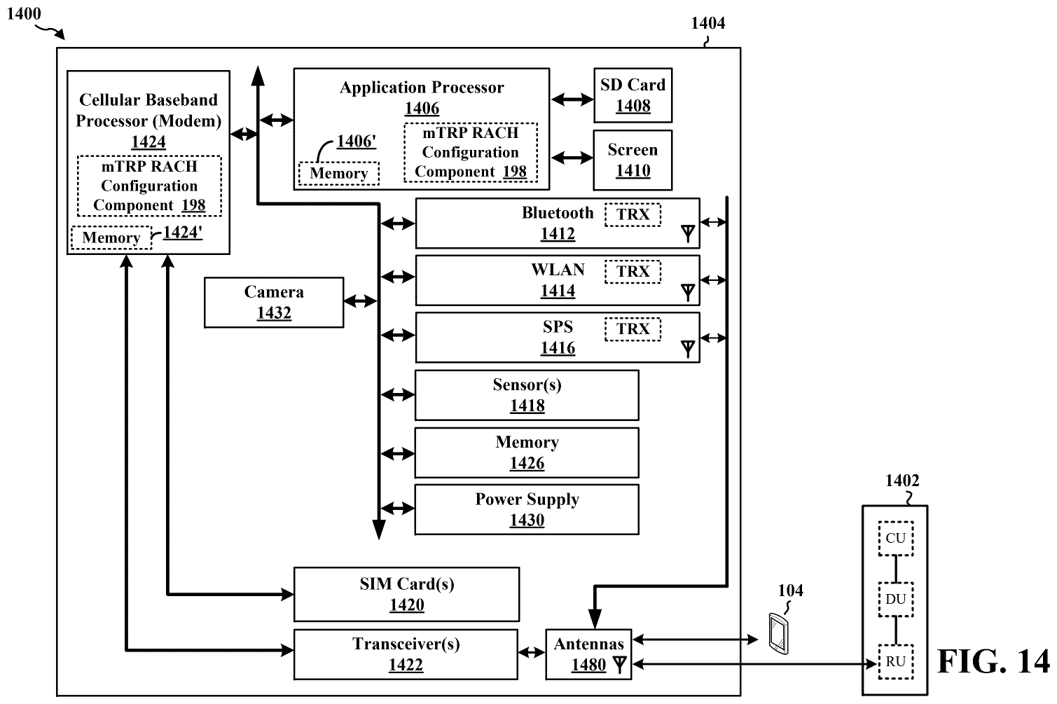

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include a cellular baseband processor 1424 (also referred to as a modem) coupled to one or more transceivers 1422 (e.g., cellular RF transceiver). The cellular baseband processor 1424 may include on-chip memory 1424′. In some aspects, the apparatus 1404 may further include one or more subscriber identity modules (SIM) cards 1420 and an application processor 1406 coupled to a secure digital (SD) card 1408 and a screen 1410. The application processor 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor 1424 communicates through the transceiver(s) 1422 via one or more antennas 1480 with the UE 104 and/or with an RU associated with a network entity 1402. The cellular baseband processor 1424 and the application processor 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor 1424 and the application processor 1406 are each responsible for general processing, including the execution of software stored on the computer-readable medium/memory. The software, when executed by the cellular baseband processor 1424/application processor 1406, causes the cellular baseband processor 1424/application processor 1406 to perform the various functions described supra. The computer-readable medium/memory may also be used for storing data that is manipulated by the cellular baseband processor 1424/application processor 1406 when executing software. The cellular baseband processor 1424/application processor 1406 may be a component of the UE 350 and may include the memory 360 and/or at least one of the TX processor 368, the RX processor 356, and the controller/processor 359. In one configuration, the apparatus 1404 may be a processor chip (modem and/or application) and include just the cellular baseband processor 1424 and/or the application processor 1406, and in another configuration, the apparatus 1404 may be the entire UE (e.g., see 350 of FIG. 3) and include the additional modules of the apparatus 1404.

As discussed supra, the mTRP RACH configuration component 198 is configured to obtain a first SRS resource set associated with a first PUSCH carrying a random access message to be transmitted to a network node, the first PUSCH being scheduled to overlap at least in part with a second PUSCH in a time domain, and transmit or refrain from transmitting, to the network node, the first PUSCH based on the first SRS resource set and a second SRS resource set associated with the second PUSCH. Also, the mTRP RACH configuration component 198 is configured to obtain a closed loop index associated with a first PUSCH carrying a random access message to be transmitted to a network node, the closed loop index indicating that a first closed loop adjustment state from the first closed loop adjustment state and a second closed loop adjustment state is to be reset, and transmit, to the network node, the first PUSCH carrying the random access message based on the closed loop index. The mTRP RACH configuration component 198 may be within the cellular baseband processor 1424, the application processor 1406, or both the cellular baseband processor 1424 and the application processor 1406. The mTRP RACH configuration component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1404 may include a variety of components configured for various functions. In one configuration, the apparatus 1404, and in particular the cellular baseband processor 1424 and/or the application processor 1406, includes means for obtaining a first SRS resource set associated with a first PUSCH carrying a random access message to be transmitted to a network node, the first PUSCH being scheduled to overlap at least in part with a second PUSCH in a time domain, and means for transmitting or refraining from transmitting, to the network node, the first PUSCH based on the first SRS resource set and a second SRS resource set associated with the second PUSCH. In one configuration, the means for transmitting or refraining from transmitting the first PUSCH is further configured to transmit the first PUSCH and the second PUSCH overlapping at least in part in the time domain based on the first SRS resource set being different from the second SRS resource set. In one configuration, the means for transmitting or refraining from transmitting the first PUSCH is further configured to dismiss the first PUSCH and the second PUSCH based on the first SRS resource set being same as the second SRS resource set. In one configuration, the means for transmitting or refraining from transmitting the first PUSCH is further configured to transmit, to the network node, one of the first PUSCH or the second PUSCH and refrain from transmitting an other one of the first PUSCH or the second PUSCH based on the first SRS resource set being same as the second SRS resource set. In one configuration, the apparatus 1404, and in particular the cellular baseband processor 1424 and/or the application processor 1406, further includes means for identifying priorities of the first PUSCH and the second PUSCH, where the one of the first PUSCH and the second PUSCH transmitted to the network node has a higher priority, and an other one of the first PUSCH or the second PUSCH refrained from transmitting to the network node has a lower priority. In one configuration, the first PUSCH carrying the random access message is scheduled in response to a random access response, and the first SRS resource set is obtained based on at least one of a random access response PDSCH, a random access response PDCCH, or a parameter associated with the random access response PDCCH. In one configuration, the first SRS resource set associated with the first PUSCH carrying the random access message is a default value configured for the UE. In one configuration, the apparatus 1404, and in particular the cellular baseband processor 1424 and/or the application processor 1406, further includes means for receiving a PDCCH including an order to initiate a random access procedure, and the first PUSCH carrying the random access message is scheduled in response to the PDCCH including the order to initiate the random access procedure, where the first SRS resource set is obtained based on at least one of the PDCCH including the order to initiate the random access procedure, or a parameter associated with the PDCCH including the order to initiate the random access procedure. In one configuration, the first SRS resource set is obtained based on at least one of a parameter associated with at least one of a SSB or a CSI-RS corresponding with the random access message, the parameter associated with PRACH occasion or preamble transmitted to the network node, or a PCI of a service cell on which the first PUSCH is scheduled. In one configuration, the apparatus 1404, and in particular the cellular baseband processor 1424 and/or the application processor 1406, includes means for obtaining a closed loop index associated with a first PUSCH carrying a random access message to be transmitted to a network node, the closed loop index indicating that a first closed loop adjustment state from the first closed loop adjustment state and a second closed loop adjustment state is to be reset, and means for transmitting, to the network node, the first PUSCH carrying the random access message based on the closed loop index. In one configuration, the apparatus 1404, and in particular the cellular baseband processor 1424 and/or the application processor 1406, further includes means for resetting the first closed loop adjustment state associated with the first PUSCH carrying the random access message based on the closed loop index. In one configuration, the closed loop index for the first PUSCH carrying the random access message is associated with a SRS resource set associated with the random access message. In one configuration, the first PUSCH carrying the random access message is scheduled in response to a random access response, and the closed loop index is obtained based on at least one of a random access response PDSCH, a random access response PDCCH, or a parameter associated with the random access response PDCCH. In one configuration, the closed loop index associated with the first PUSCH carrying the random access message is a default value configured for the UE. In one configuration, the apparatus 1404, and in particular the cellular baseband processor 1424 and/or the application processor 1406, further includes means for receiving a PDCCH including an order to initiate a random access procedure, and the first PUSCH carrying the random access message is scheduled in response to the PDCCH including the order to initiate the random access procedure, where the closed loop index is obtained based on at least one of the PDCCH including the order to initiate the random access procedure, or a parameter associated with the PDCCH including the order to initiate the random access procedure. In one configuration, the closed loop index is obtained based on at least one of a parameter associated with at least one of a SSB or a CSI-RS corresponding with the random access message, the parameter associated with PRACH occasion or preamble transmitted to the network node, or a PCI of a service cell on which the first PUSCH is scheduled. The means may be the mTRP RACH configuration component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

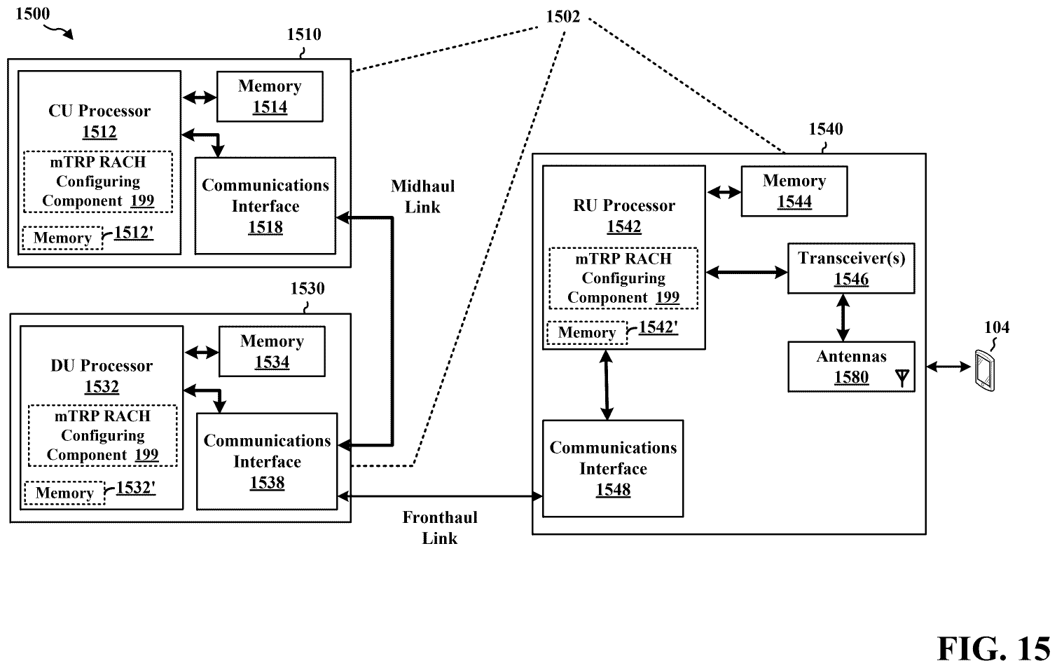

FIG. 15 is a diagram 1500 illustrating an example of a hardware implementation for a network entity 1502. The network entity 1502 may be a BS, a component of a BS, or may implement BS functionality. The network entity 1502 may include at least one of a CU 1510, a DU 1530, or an RU 1540. For example, depending on the layer functionality handled by the mTRP RACH configuring component 199, the network entity 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include a CU processor 1512. The CU processor 1512 may include on-chip memory 1512′. In some aspects, the CU 1510 may further include additional memory modules 1514 and a communications interface 1518. The CU 1510 communicates with the DU 1530 through a midhaul link, such as an F1 interface. The DU 1530 may include a DU processor 1532. The DU processor 1532 may include on-chip memory 1532′. In some aspects, the DU 1530 may further include additional memory modules 1534 and a communications interface 1538. The DU 1530 communicates with the RU 1540 through a fronthaul link. The RU 1540 may include an RU processor 1542. The RU processor 1542 may include on-chip memory 1542′. In some aspects, the RU 1540 may further include additional memory modules 1544, one or more transceivers 1546, antennas 1580, and a communications interface 1548. The RU 1540 communicates with the UE 104. The on-chip memory 1512′, 1532′, 1542′ and the additional memory modules 1514, 1534, 1544 may each be considered a computer-readable medium/memory. Each computer-readable medium/memory may be non-transitory. Each of the processors 1512, 1532, 1542 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the mTRP RACH configuring component 199 is configured to transmit, for a UE an indication of at least one of a first SRS resource set or a closed loop index associated with a first PUSCH carrying a random access message to be transmitted to a network node, the first PUSCH being scheduled to overlap at least in part with a second PUSCH in a time domain, and receive at least one of the first PUSCH or the second PUSCH based on the first SRS resource set and a second SRS resource set associated with the second PUSCH. Also, the mTRP RACH configuring component 199 is configured to transmit, for a UE an indication of a closed loop index associated with a first PUSCH carrying a random access message to be transmitted by the UE, and receive the first PUSCH carrying the random access message based on the closed loop index. The mTRP RACH configuring component 199 may be within one or more processors of one or more of the CU 1510, DU 1530, and the RU 1540. The mTRP RACH configuring component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1502 may include a variety of components configured for various functions. In one configuration, the network entity 1502 includes means for transmitting, for a UE an indication of a first SRS resource set associated with a first PUSCH carrying a random access message to be transmitted by the UE, the first PUSCH being scheduled to overlap at least in part with a second PUSCH in a time domain, and means for receiving at least one of the first PUSCH or the second PUSCH based on the first SRS resource set and a second SRS resource set associated with the second PUSCH. In one configuration, the first PUSCH is received based on the first SRS resource set being different from the second SRS resource set. In one configuration, the first PUSCH is received based on the first SRS resource set being same as the second SRS resource set and the first PUSCH having a higher priority than the second PUSCH. In one configuration, the indication of the first SRS resource set associated with the first PUSCH carrying the random access message includes at least one of a random access response PDSCH, a random access response PDCCH, or a parameter associated with the random access response PDCCH. In one configuration, the first SRS resource set associated with the first PUSCH carrying the random access message is a default value configured for the UE. In one configuration, the indication of the first SRS resource set associated with the first PUSCH carrying the random access message is transmitted via a PDCCH including an order to initiate a random access procedure, and the indication includes at least one of the PDCCH including the order to initiate the random access procedure, or a parameter associated with the PDCCH including the order to initiate the random access procedure. In one configuration, the indication of the first SRS resource set associated with the first PUSCH carrying the random access message includes at least one of a parameter associated with at least one of a SSB or a CSI-RS corresponding with the random access message, the parameter associated with PRACH occasion or preamble transmitted to the network node, or a PCI of a service cell on which the first PUSCH is scheduled. In one configuration, the network entity 1502 includes means for transmitting, for a UE, an indication of a closed loop index associated with a first PUSCH carrying a random access message to be transmitted by the UE, the closed loop index indicating that a first closed loop adjustment state from the first closed loop adjustment state and a second closed loop adjustment state is to be reset, and means for receiving the first PUSCH carrying the random access message based on the closed loop index. In one configuration, a first closed loop adjustment state associated with the first PUSCH carrying the random access message is reset based on the closed loop index. In one configuration, the closed loop index associated with the first PUSCH carrying the random access message is associated with a SRS resource set associated with the random access message. In one configuration, the indication of the closed loop index associated with the first PUSCH carrying the random access message includes at least one of a random access response PDSCH, a random access response PDCCH, or a parameter associated with the random access response PDCCH. In one configuration, the closed loop index associated with the first PUSCH carrying the random access message is a default value configured for the UE. In one configuration, the indication of the closed loop index associated with the first PUSCH carrying the random access message is transmitted via a PDCCH including an order to initiate a random access procedure, and the indication includes at least one of the PDCCH including the order to initiate the random access procedure, or a parameter associated with the PDCCH including the order to initiate the random access procedure. In one configuration, the indication of the closed loop index associated with the first PUSCH carrying the random access message includes at least one of a parameter associated with at least one of a SSB or a CSI-RS corresponding with the random access message, the parameter associated with PRACH occasion or preamble transmitted to the network node, or a PCI of a service cell on which the first PUSCH is scheduled. The means may be the mTRP RACH configuring component 199 of the network entity 1502 configured to perform the functions recited by the means. As described supra, the network entity 1502 may include the TX processor 316, the RX processor 370, and the controller/processor 375. As such, in one configuration, the means may be the TX processor 316, the RX processor 370, and/or the controller/processor 375 configured to perform the functions recited by the means.

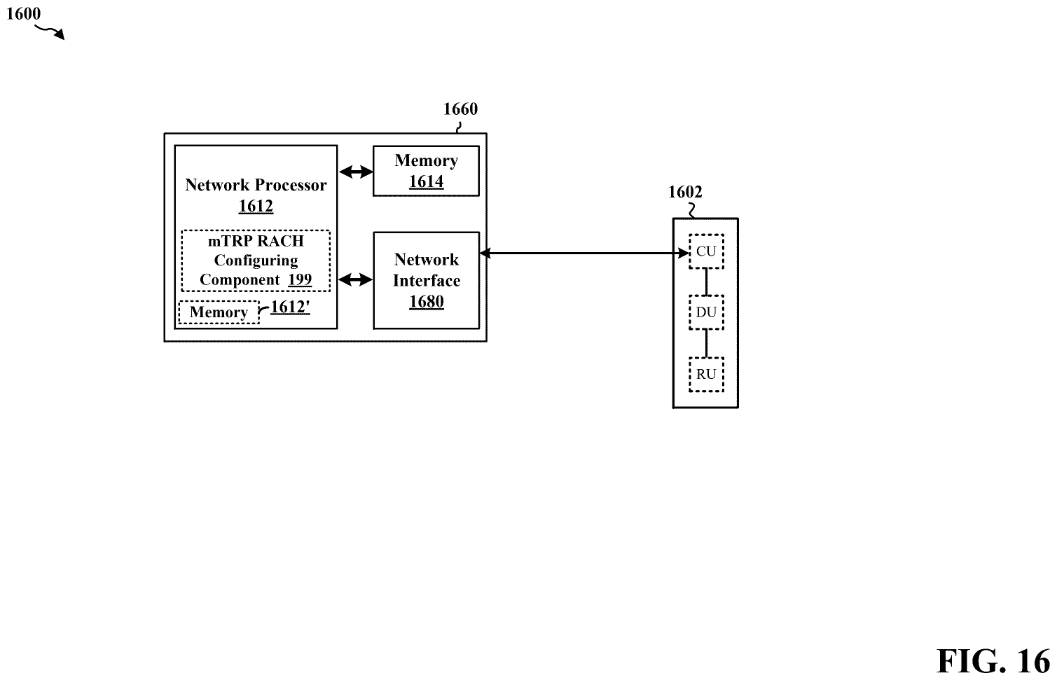

FIG. 16 is a diagram 1600 illustrating an example of a hardware implementation for a network entity 1660. In one example, the network entity 1660 may be within the core network 150. The network entity 1660 may include a network processor 1612. The network processor 1612 may include on-chip memory 1612′. In some aspects, the network entity 1660 may further include additional memory modules 1614. The network entity 1660 communicates via the network interface 1680 directly (e.g., backhaul link) or indirectly (e.g., through a RIC) with the CU 1602. The on-chip memory 1612′ and the additional memory modules 1614 may each be considered a computer-readable medium/memory. Each computer-readable medium/memory may be non-transitory. The processor 1612 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the mTRP RACH configuring component 199 is configured to transmit, for a UE an indication of at least one of a first SRS resource set or a closed loop index associated with a first PUSCH carrying a random access message to be transmitted to a network node, the first PUSCH being scheduled to overlap at least in part with a second PUSCH in a time domain, and receive at least one of the first PUSCH or the second PUSCH based on the first SRS resource set and a second SRS resource set associated with the second PUSCH. Also, the mTRP RACH configuring component 199 is configured to transmit, for a UE an indication of a closed loop index associated with a first PUSCH carrying a random access message to be transmitted by the UE, and receive the first PUSCH carrying the random access message based on the closed loop index. The mTRP RACH configuring component 199 may be within the processor 1612. The mTRP RACH configuring component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1660 may include a variety of components configured for various functions. In one configuration, the network entity 1660 includes means for transmitting, for a UE an indication of a first SRS resource set associated with a first PUSCH carrying a random access message to be transmitted by the UE, the first PUSCH being scheduled to overlap at least in part with a second PUSCH in a time domain, and means for receiving at least one of the first PUSCH or the second PUSCH based on the first SRS resource set and a second SRS resource set associated with the second PUSCH. In one configuration, the first PUSCH is received based on the first SRS resource set being different from the second SRS resource set. In one configuration, the first PUSCH is received based on the first SRS resource set being same as the second SRS resource set and the first PUSCH having a higher priority than the second PUSCH. In one configuration, the indication of the first SRS resource set associated with the first PUSCH carrying the random access message includes at least one of a random access response PDSCH, a random access response PDCCH, or a parameter associated with the random access response PDCCH. In one configuration, the first SRS resource set associated with the first PUSCH carrying the random access message is a default value configured for the UE. In one configuration, the indication of the first SRS resource set associated with the first PUSCH carrying the random access message is transmitted via a PDCCH including an order to initiate a random access procedure, and the indication includes at least one of the PDCCH including the order to initiate the random access procedure, or a parameter associated with the PDCCH including the order to initiate the random access procedure. In one configuration, the indication of the first SRS resource set associated with the first PUSCH carrying the random access message includes at least one of a parameter associated with at least one of a SSB or a CSI-RS corresponding with the random access message, the parameter associated with PRACH occasion or preamble transmitted to the network node, or a PCI of a service cell on which the first PUSCH is scheduled. In one configuration, the network entity 1660 includes means for transmitting, for a UE, an indication of a closed loop index associated with a first PUSCH carrying a random access message to be transmitted by the UE, the closed loop index indicating that a first closed loop adjustment state from the first closed loop adjustment state and a second closed loop adjustment state is to be reset, and means for receiving the first PUSCH carrying the random access message based on the closed loop index. In one configuration, a first closed loop adjustment state associated with the first PUSCH carrying the random access message is reset based on the closed loop index. In one configuration, the closed loop index associated with the first PUSCH carrying the random access message is associated with a SRS resource set associated with the random access message. In one configuration, the indication of the closed loop index associated with the first PUSCH carrying the random access message includes at least one of a random access response PDSCH, a random access response PDCCH, or a parameter associated with the random access response PDCCH. In one configuration, the closed loop index associated with the first PUSCH carrying the random access message is a default value configured for the UE. In one configuration, the indication of the closed loop index associated with the first PUSCH carrying the random access message is transmitted via a PDCCH including an order to initiate a random access procedure, and the indication includes at least one of the PDCCH including the order to initiate the random access procedure, or a parameter associated with the PDCCH including the order to initiate the random access procedure. In one configuration, the indication of the closed loop index associated with the first PUSCH carrying the random access message includes at least one of a parameter associated with at least one of a SSB or a CSI-RS corresponding with the random access message, the parameter associated with PRACH occasion or preamble transmitted to the network node, or a PCI of a service cell on which the first PUSCH is scheduled. The means may be the mTRP RACH configuring component 199 of the network entity 1660 configured to perform the functions recited by the means.

In some aspects of the current disclosure, a UE and multiple TRPs may be configured with a multi-DCI based mTRP transmission. The UE may be configured to obtain a first SRS resource set associated with a first PUSCH carrying a random access message to be transmitted to a TRP, the first PUSCH being scheduled to overlap at least in part with a second PUSCH in a time domain, and transmit or refrain from transmitting, to the TRP, the first PUSCH based on the first SRS resource set and a second SRS resource set associated with the second PUSCH. The TRP may be configured to transmit, for the UE an indication of at least one of a first SRS resource set or a closed loop index associated with a first PUSCH carrying a random access message to be transmitted by the UE, the first PUSCH being scheduled to overlap at least in part with a second PUSCH in a time domain, and receive at least one of the first PUSCH or the second PUSCH based on the first SRS resource set and a second SRS resource set associated with the second PUSCH

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including obtaining a first SRS resource set associated with a first PUSCH carrying a random access message to be transmitted to a network node, the first PUSCH being scheduled to overlap at least in part with a second PUSCH in a time domain, and transmitting or refraining from transmitting, to the network node, the first PUSCH based on the first SRS resource set and a second SRS resource set associated with the second PUSCH.

Aspect 2 is the method of aspect 1, where the transmitting or refraining from transmitting the first PUSCH further includes transmitting the first PUSCH and the second PUSCH overlapping at least in part in the time domain based on the first SRS resource set being different from the second SRS resource set.

Aspect 3 is the method of any of aspects 1 and 2, where the transmitting or refraining from transmitting the first PUSCH further includes dismissing the first PUSCH and the second PUSCH based on the first SRS resource set being same as the second SRS resource set.

Aspect 4 is the method of any of aspects 1 to 3, where the transmitting or refraining from transmitting the first PUSCH further includes transmitting, to the network node, one of the first PUSCH or the second PUSCH and refrain from transmitting an other one of the first PUSCH or the second PUSCH based on the first SRS resource set being same as the second SRS resource set.

Aspect 5 is the method of aspect 4, further including identifying priorities of the first PUSCH and the second PUSCH, where the one of the first PUSCH and the second PUSCH transmitted to the network node has a higher priority, and an other one of the first PUSCH or the second PUSCH refrained from transmitting to the network node has a lower priority.

Aspect 6 is the method of any of aspects 1 to 5, where the first PUSCH carrying the random access message is scheduled in response to a random access response, and the first SRS resource set is obtained based on at least one of a random access response PDSCH, a random access response PDCCH, or a parameter associated with the random access response PDCCH.

Aspect 7 is the method of any of aspects 1 to 6, where the first SRS resource set associated with the first PUSCH carrying the random access message is a default value configured for the UE.

Aspect 8 is the method of any of aspects 1 to 7, further including receiving a PDCCH including an order to initiate a random access procedure, and the first PUSCH carrying the random access message is scheduled in response to the PDCCH including the order to initiate the random access procedure, where the first SRS resource set is obtained based on at least one of the PDCCH including the order to initiate the random access procedure, or a parameter associated with the PDCCH including the order to initiate the random access procedure.

Aspect 9 is the method of any of aspects 1 to 8, where the first SRS resource set is obtained based on at least one of a parameter associated with at least one of a SSB or a CSI-RS corresponding with the random access message, the parameter associated with PRACH occasion or preamble transmitted to the network node, or a PCI of a service cell on which the first PUSCH is scheduled.

Aspect 10 is a method of wireless communication at a UE, including obtaining a closed loop index associated with a first PUSCH carrying a random access message to be transmitted to a network node, the closed loop index indicating that a first closed loop adjustment state from the first closed loop adjustment state and a second closed loop adjustment state is to be reset, and transmitting, to the network node, the first PUSCH carrying the random access message based on the closed loop index.

Aspect 11 is the method of aspect 10, further including resetting the first closed loop adjustment state associated with the first PUSCH carrying the random access message based on the closed loop index.

Aspect 12 is the method of any of aspects 10 and 11, where the closed loop index for the first PUSCH carrying the random access message is associated with a SRS resource set associated with the random access message.

Aspect 13 is the method of any of aspects 10 to 12, where the first PUSCH carrying the random access message is scheduled in response to a random access response, and the closed loop index is obtained based on at least one of a random access response PDSCH, a random access response PDCCH, or a parameter associated with the random access response PDCCH.

Aspect 14 is the method of any of aspects 10 to 13, where the closed loop index associated with the first PUSCH carrying the random access message is a default value configured for the UE.

Aspect 15 is the method of any of aspects 10 to 14, further including receiving a PDCCH including an order to initiate a random access procedure, and the first PUSCH carrying the random access message is scheduled in response to the PDCCH including the order to initiate the random access procedure, where the closed loop index is obtained based on at least one of the PDCCH including the order to initiate the random access procedure, or a parameter associated with the PDCCH including the order to initiate the random access procedure.

Aspect 16 is the method of any of aspects 10 to 15, where the closed loop index is obtained based on at least one of a parameter associated with at least one of a SSB or a CSI-RS corresponding with the random access message, the parameter associated with PRACH occasion or preamble transmitted to the network node, or a PCI of a service cell on which the first PUSCH is scheduled.

Aspect 17 is an apparatus for wireless communication including at least one processor coupled to a memory and configured to implement any of aspects 1 to 16, further including a transceiver coupled to the at least one processor.

Aspect 18 is an apparatus for wireless communication including means for implementing any of aspects 1 to 16.

Aspect 19 is a non-transitory computer-readable medium storing computer executable code, where the code when executed by a processor causes the processor to implement any of aspects 1 to 16.

Aspect 20 is a method of wireless communication at a network node, including transmitting, for a UE an indication of a first SRS resource set associated with a first PUSCH carrying a random access message to be transmitted by the UE, the first PUSCH being scheduled to overlap at least in part with a second PUSCH in a time domain, and receiving at least one of the first PUSCH or the second PUSCH based on the first SRS resource set and a second SRS resource set associated with the second PUSCH.

Aspect 21 is the method of aspect 20, where the first PUSCH is received based on the first SRS resource set being different from the second SRS resource set.

Aspect 22 is the method of any of aspects 20 and 21, where the first PUSCH is received based on the first SRS resource set being same as the second SRS resource set and the first PUSCH having a higher priority than the second PUSCH.

Aspect 23 is the method of any of aspects 20 to 22, where the indication of the first SRS resource set associated with the first PUSCH carrying the random access message includes at least one of a random access response PDSCH, a random access response PDCCH, or a parameter associated with the random access response PDCCH.

Aspect 24 is the method of any of aspects 20 to 23, where the first SRS resource set associated with the first PUSCH carrying the random access message is a default value configured for the UE.

Aspect 25 is the method of any of aspects 20 to 24, where the indication of the first SRS resource set associated with the first PUSCH carrying the random access message is transmitted via a PDCCH including an order to initiate a random access procedure, and the indication includes at least one of the PDCCH including the order to initiate the random access procedure, or a parameter associated with the PDCCH including the order to initiate the random access procedure.

Aspect 26 is the method of any of aspects 20 to 25, where the indication of the first SRS resource set associated with the first PUSCH carrying the random access message includes at least one of a parameter associated with at least one of a SSB or a CSI-RS corresponding with the random access message, the parameter associated with PRACH occasion or preamble transmitted to the network node, or a PCI of a service cell on which the first PUSCH is scheduled.

Aspect 27 is a method of wireless communication at a network node, including transmitting, for a UE, an indication of a closed loop index associated with a first PUSCH carrying a random access message to be transmitted by the UE, the closed loop index indicating that a first closed loop adjustment state from the first closed loop adjustment state and a second closed loop adjustment state is to be reset, and receiving the first PUSCH carrying the random access message based on the closed loop index.

Aspect 28 is the method of aspect 27, where a first closed loop adjustment state associated with the first PUSCH carrying the random access message is reset based on the closed loop index.

Aspect 29 is the method of any of aspects 27 and 28, where the closed loop index associated with the first PUSCH carrying the random access message is associated with a SRS resource set associated with the random access message.

Aspect 30 is the method of any of aspects 27 to 29, where the indication of the closed loop index associated with the first PUSCH carrying the random access message includes at least one of a random access response PDSCH, a random access response PDCCH, or a parameter associated with the random access response PDCCH.

Aspect 31 is the method of any of aspects 27 to 30, where the closed loop index associated with the first PUSCH carrying the random access message is a default value configured for the UE.

Aspect 32 is the method of any of aspects 27 to 31, where the indication of the closed loop index associated with the first PUSCH carrying the random access message is transmitted via a PDCCH including an order to initiate a random access procedure, and the indication includes at least one of the PDCCH including the order to initiate the random access procedure, or a parameter associated with the PDCCH including the order to initiate the random access procedure.

Aspect 33 is the method of any of aspects 27 to 32, where the indication of the closed loop index associated with the first PUSCH carrying the random access message includes at least one of a parameter associated with at least one of a SSB or a CSI-RS corresponding with the random access message, the parameter associated with PRACH occasion or preamble transmitted to the network node, or a PCI of a service cell on which the first PUSCH is scheduled.

Aspect 34 is an apparatus for wireless communication including at least one processor coupled to a memory and configured to implement any of aspects 20 to 33, further including a transceiver coupled to the at least one processor.

Aspect 35 is an apparatus for wireless communication including means for implementing any of aspects 20 to 33.

Aspect 36 is a non-transitory computer-readable medium storing computer executable code, where the code when executed by a processor causes the processor to implement any of aspects 20 to 33.

What is claimed is:

1. An apparatus for wireless communication at a user equipment (UE), comprising:
a memory; and
at least one processor coupled to the memory and, based at least in part on information stored in the memory, the at least one processor is configured to:
obtain a first sounding reference signal (SRS) resource set associated with a first physical uplink shared channel (PUSCH) carrying a random access message to be transmitted to a network node, the first PUSCH being scheduled to overlap at least in part with a second PUSCH in a time domain; and
transmit or refrain from transmitting, to the network node, the first PUSCH based on the first SRS resource set and a second SRS resource set associated with the second PUSCH.

2. The apparatus of claim 1, further comprising a transceiver coupled to the at least one processor,
wherein, to transmit or refrain from transmitting the first PUSCH, the at least one processor is further configured to:
transmit the first PUSCH and the second PUSCH overlapping at least in part in the time domain based on the first SRS resource set being different from the second SRS resource set.

3. The apparatus of claim 1, wherein, to transmit or refrain from transmitting the first PUSCH, the at least one processor is further configured to:
dismiss the first PUSCH and the second PUSCH based on the first SRS resource set being same as the second SRS resource set.

4. The apparatus of claim 1, wherein, to transmit or refrain from transmitting the first PUSCH, the at least one processor is further configured to:
transmit, to the network node, one of the first PUSCH or the second PUSCH and refrain from transmitting an other one of the first PUSCH or the second PUSCH based on the first SRS resource set being same as the second SRS resource set.

5. The apparatus of claim 4, wherein the at least one processor is further configured to identify priorities of the first PUSCH and the second PUSCH,
wherein the one of the first PUSCH and the second PUSCH transmitted to the network node has a higher priority, and an other one of the first PUSCH or the second PUSCH refrained from transmitting to the network node has a lower priority.

6. The apparatus of claim 1, wherein the first PUSCH carrying the random access message is scheduled in response to a random access response, and the first SRS resource set is obtained based on at least one of:
a random access response PDSCH;
a random access response physical downlink control channel (PDCCH); or
a parameter associated with the random access response PDCCH.

7. The apparatus of claim 1, wherein the first SRS resource set associated with the first PUSCH carrying the random access message is a default value configured for the UE.

8. The apparatus of claim 1, wherein the at least one processor is further configured to receive a physical downlink control channel (PDCCH) including an order to initiate a random access procedure, and the first PUSCH carrying the random access message is scheduled in response to the PDCCH including the order to initiate the random access procedure,
wherein the first SRS resource set is obtained based on at least one of:
the PDCCH including the order to initiate the random access procedure; or
a parameter associated with the PDCCH including the order to initiate the random access procedure.

9. The apparatus of claim 1, wherein the first SRS resource set is obtained based on at least one of:
a parameter associated with at least one of a synchronization signal block (SSB) or a channel state information reference signal (CSI-RS) corresponding with the random access message;
the parameter associated with physical random access channel (PRACH) occasion or preamble transmitted to the network node; or
a physical cell identifier (ID) (PCI) of a service cell on which the first PUSCH is scheduled.

10. An apparatus for wireless communication at a user equipment (UE), comprising:
a memory; and
at least one processor coupled to the memory and, based at least in part on information stored in the memory, the at least one processor is configured to:
obtain a closed loop index associated with a first physical uplink shared channel (PUSCH) carrying a random access message to be transmitted to a network node, the closed loop index indicating that a first closed loop adjustment state from the first closed loop adjustment state and a second closed loop adjustment state is to be reset; and
transmit, to the network node, the first PUSCH carrying the random access message based on the closed loop index.

11. The apparatus of claim 10, wherein the at least one processor is further configured to:
reset the first closed loop adjustment state associated with the first PUSCH carrying the random access message based on the closed loop index.

12. The apparatus of claim 10, wherein the closed loop index for the first PUSCH carrying the random access message is associated with a sounding reference signal (SRS) resource set associated with the random access message.

13. The apparatus of claim 10, wherein the first PUSCH carrying the random access message is scheduled in response to a random access response, and the closed loop index is obtained based on at least one of:
a random access response PDSCH;
a random access response physical downlink control channel (PDCCH); or
a parameter associated with the random access response PDCCH.

14. The apparatus of claim 10, wherein the closed loop index associated with the first PUSCH carrying the random access message is a default value configured for the UE.

15. The apparatus of claim 10, wherein the at least one processor is further configured to receive a physical downlink control channel (PDCCH) including an order to initiate a random access procedure, and the first PUSCH carrying the random access message is scheduled in response to the PDCCH including the order to initiate the random access procedure,
wherein the closed loop index is obtained based on at least one of:
the PDCCH including the order to initiate the random access procedure; or
a parameter associated with the PDCCH including the order to initiate the random access procedure.

16. The apparatus of claim 10, wherein the closed loop index is obtained based on at least one of:
a parameter associated with at least one of a synchronization signal block (SSB) or a channel state information reference signal (CSI-RS) corresponding with the random access message;
the parameter associated with physical random access channel (PRACH) occasion or preamble transmitted to the network node; or
a physical cell identifier (ID) (PCI) of a service cell on which the first PUSCH is scheduled.

17. An apparatus for wireless communication at a network node, comprising:
a memory; and
at least one processor coupled to the memory and, based at least in part on information stored in the memory, the at least one processor is configured to:
transmit, for a user equipment (UE) an indication of a first SRS resource set associated with a first physical uplink shared channel (PUSCH) carrying a random access message to be transmitted by the UE, the first PUSCH being scheduled to overlap at least in part with a second PUSCH in a time domain; and
receive at least one of the first PUSCH or the second PUSCH based on the first SRS resource set and a second SRS resource set associated with the second PUSCH.

18. The apparatus of claim 17, further comprising a transceiver coupled to the at least one processor, and wherein the first PUSCH is received based on the first SRS resource set being different from the second SRS resource set.

19. The apparatus of claim 17, wherein the first PUSCH is received based on the first SRS resource set being same as the second SRS resource set and the first PUSCH having a higher priority than the second PUSCH.

20. The apparatus of claim 17, wherein the indication of the first SRS resource set associated with the first PUSCH carrying the random access message includes at least one of:
a random access response PDSCH;
a random access response physical downlink control channel (PDCCH); or
a parameter associated with the random access response PDCCH.

21. The apparatus of claim 17, wherein the first SRS resource set associated with the first PUSCH carrying the random access message is a default value configured for the UE.

22. The apparatus of claim 17, wherein the indication of the first SRS resource set associated with the first PUSCH carrying the random access message is transmitted via a physical downlink control channel (PDCCH) including an order to initiate a random access procedure, and the indication includes at least one of:
the PDCCH including the order to initiate the random access procedure; or
a parameter associated with the PDCCH including the order to initiate the random access procedure.

23. The apparatus of claim 17, wherein the indication of the first SRS resource set associated with the first PUSCH carrying the random access message includes at least one of:
a parameter associated with at least one of a synchronization signal block (SSB) or a channel state information reference signal (CSI-RS) corresponding with the random access message;
the parameter associated with physical random access channel (PRACH) occasion or preamble transmitted to the network node; or
a physical cell identifier (ID) (PCI) of a service cell on which the first PUSCH is scheduled.

24. An apparatus for wireless communication at a network node, comprising:
a memory; and
at least one processor coupled to the memory and, based at least in part on information stored in the memory, the at least one processor is configured to:
transmit, for a user equipment (UE), an indication of a closed loop index associated with a first physical uplink shared channel (PUSCH) carrying a random access message to be transmitted by the UE, the closed loop index indicating that a first closed loop adjustment state from the first closed loop adjustment state and a second closed loop adjustment state is to be reset; and
receive the first PUSCH carrying the random access message based on the closed loop index.

25. The apparatus of claim 24, wherein a first closed loop adjustment state associated with the first PUSCH carrying the random access message is reset based on the closed loop index.

26. The apparatus of claim 24, wherein the closed loop index associated with the first PUSCH carrying the random access message is associated with a sounding reference signal (SRS) resource set associated with the random access message.

27. The apparatus of claim 24, wherein the indication of the closed loop index associated with the first PUSCH carrying the random access message includes at least one of:
a random access response PDSCH;
a random access response physical downlink control channel (PDCCH); or
a parameter associated with the random access response PDCCH.

28. The apparatus of claim 24, wherein the closed loop index associated with the first PUSCH carrying the random access message is a default value configured for the UE.

29. The apparatus of claim 24, wherein the indication of the closed loop index associated with the first PUSCH carrying the random access message is transmitted via a physical downlink control channel (PDCCH) including an order to initiate a random access procedure, and the indication includes at least one of:
the PDCCH including the order to initiate the random access procedure; or
a parameter associated with the PDCCH including the order to initiate the random access procedure.

30. The apparatus of claim 24, wherein the indication of the closed loop index associated with the first PUSCH carrying the random access message includes at least one of:
a parameter associated with at least one of a synchronization signal block (SSB) or a channel state information reference signal (CSI-RS) corresponding with the random access message;
the parameter associated with physical random access channel (PRACH) occasion or preamble transmitted to the network node; or
a physical cell identifier (ID) (PCI) of a service cell on which the first PUSCH is scheduled.
